(19) United States
(12) Patent Application Publication
(10) Pub. No.: US 2013/0147743 A1
(43) Pub. Date: Jun. 13, 2013

(54) Spherical Touch Sensors and Signal/Power Architectures for Trackballs, Globes, Displays, and Other Applications

(71) Applicant: LESTER F. LUDWIG, SAN ANTONIO, TX (US)

(72) Inventor: LESTER F. LUDWIG, SAN ANTONIO, TX (US)

(21) Appl. No.: 13/712,749

(22) Filed: Dec. 12, 2012

Related U.S. Application Data
(60) Provisional application No. 61/569,522, filed on Dec. 12, 2011.

(51) Int. Cl. G06F 3/041

(52) U.S. Cl. CPC G06F 3/041
USPC 345/173

(57) ABSTRACT

Embodiments of the present invention relate to a spherically-shaped user interface device comprising a tactile sensing arrangement for at least generating tactile sensing measurements in response to tactile input on a spherically-shaped surface and a processor for processing the tactile sensing measurements and producing user interface signals responsive to user touch. The tactile sensing can use capacitive or optical methods employing, for example a spherically-arranged array of Organic Light Emitting Diodes (OLEDs). Employing high resolution and lensless imaging, the latter arrangement can provide a range of additional valuable functions, such as operation as a fingerprint sensor. lensless camera, and 3-space hand gesture detector. The device can be used as a trackball, interactive globe, and many other applications.

### CROSS-REFERENCE TO RELATED APPLICATIONS

This application claims benefit of priority from Provisional U.S. Patent application Ser. No. 61/569,522, filed Dec. 12, 2011, the contents of which are incorporated by reference.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### FIELD OF THE INVENTION

This invention relates to sensor arrangements and signal processing architectures for touch-based user interfaces, and more specifically to spherical touch sensors and signal/power architectures for trackballs, globes, displays, and other applications.

### BACKGROUND

By way of general introduction, touch screens implementing tactile sensor arrays have recently received tremendous attention with the addition multi-touch sensing, metaphors, and gestures. After an initial commercial appearance in the products of FingerWorks™, such advanced touch screen technologies have received great commercial success from their defining role in the iPhone™ and subsequent adaptations in PDAs and other types of cell phones and hand-held devices. Despite this popular notoriety and the many associated patent filings, tactile array sensors implemented as transparent touchscreens were taught in the 1999 filings of issued U.S. Pat. No. 6,570,078 and pending U.S. patent application Ser. No. 11/761,978.

Despite the many popular touch interfaces and gestures, there remains a wide range of additional control capabilities that can yet be provided by further enhanced user interface technologies. A number of enhanced touch user interface features are described in U.S. Pat. Nos. 6,570,078 and 8,169,414 as well as, pending U.S. patent application Ser. Nos. 11/761,978, 12/418,605, 12/502,230, 12/541,948, and a significant number of related pending U.S. patent applications by the present and associated inventors. These patents and patent applications also address popular contemporary gesture and touch features. The enhanced user interface features taught in these patents and patent applications, together with popular contemporary gesture and touch features, can be rendered by the “High Dimensional Touch Pad” (HDTP) technology taught in those patents and patent applications. Implementations of the HTDP provide advanced multi-touch capabilities far more sophisticated that those popularized by FingerWorks™, Apple™, NYU, Microsoft™, Gesturetek™, and others.

### Example Devices and Configurations Employing a Touchpad or Touchscreen

FIGS. 1a-1g (adapted from U.S. patent application Ser. No. 12/418,605) and 2a-2e (adapted from U.S. Pat. No. 7,557,797) depict a number of arrangements and implementations employing a touch-based user interface. FIG. 1a illustrates a touch-based user interface as a peripheral that can be used with a desktop computer (shown) or laptop) not shown). FIG. 1b depicts a touch-based user interface integrated into a laptop in place of the traditional touchpad pointing device. In FIGS. 1a-1b a touch-based user interface tactile sensor can be a stand-alone component or can be integrated over a display so as to form a touchscreen. FIG. 1c depicts a touch-based user interface integrated into a desktop computer display so as to form a touchscreen. FIG. 1d shows a touch-based user interface integrated into a laptop computer display so as to form a touchscreen.

FIG. 1e depicts a touch-based user interface integrated into a cell phone, smartphone, PDA, or other hand-held consumer device. FIG. 1f shows a touch-based user interface integrated into a test instrument, portable service-tracking device, portable service-entry device, field instrument, or other hand-held industrial device. In FIGS. 1e-1f a touch-based user interface tactile sensor can be a stand-alone component or can be integrated over a display so as to form a touchscreen. FIG. 1g depicts a user interface touchscreen configuration that can be used in a tablet computer, wall-mount computer monitor, digital television, video conferencing screen, kiosk, etc. In at least the arrangements of FIGS. 1a, 1c, 1d, and 1g, or other sufficiently large tactile sensor implementation of a touch-based user interface, more than one hand can be used an individually recognized as such.

FIGS. 2a-2e and FIGS. 3a-3b (these adapted from U.S. Pat. No. 7,557,797) depict various integrations of a touch-based user interface into the back of a conventional computer mouse. Any of these arrangements can employ a connecting cable, or the device can be wireless.

In the integrations depicted in FIGS. 2a-2d a touch-based user interface tactile sensor can be a stand-alone component or can be integrated over a display so as to form a touchscreen. Such configurations have very recently become popularized by the product release of Apple™ “Magic Mouse™” although such combinations of a mouse with a tactile sensor array on its back responsive to multitouch and gestures were taught earlier in pending U.S. patent application Ser. No. 12/619,678 (priority date Feb. 12, 2004) entitled “User Interface Mouse with Touchpad Responsive to Gestures and Multi-Touch.”

In another implementation taught in the specification of issued U.S. Pat. No. 7,557,797 and associated pending continuation applications more than two touchpads can be included in the advance mouse embodiment, for example as suggested in the arrangement of FIG. 2e. As with the arrangements of FIGS. 2a-2d, one or more of the plurality of touch-based user interface tactile sensors or exposed sensor areas of arrangements such as that of FIG. 2e can be integrated over a display so as to form a touchscreen. Other advance mouse arrangements include the integrated trackball/touchpad/mouse combinations of FIGS. 3a-3b taught in U.S. Pat. No. 7,557,797.

### Overview of Touch-based User Interface Sensor Technology

The information in this section provides an overview of HDTP user interface technology as described in U.S. Pat. Nos. 6,570,078 and 8,169,414 as well as pending U.S. patent application Ser. Nos. 11/761,978, 12/418,605, 12/502,230, 12/541,948, and related pending U.S. patent applications.

As an example, a touchpad used as a pointing and data entry device can comprise an array of sensors. The array of sensors is used to create a tactile image of a type associated with the type of sensor and method of contact by the human hand. The individual sensors in the sensor array can be pressure sensors and a direct pressure-sensing tactile image is generated by the sensor array. Alternatively, the individual sensors in the sensor array can be proximity sensors and a direct proximity tactile image is generated by the sensor array. Since the contacting surfaces of the finger or hand tissue contacting a surface typically increasingly deforms as pressure is applied, the sensor array comprised of proximity sensors also provides an indirect pressure-sensing tactile image. Alternatively, the individual sensors in the sensor array can be optical sensors. In one variation of this, an optical image is generated and an indirect proximity tactile image is generated by the sensor array. In another variation, the optical image can be observed through a transparent or translucent rigid material and, as the contacting surfaces of the finger or hand tissue contacting a surface typically increasingly deforms as pressure is applied, the optical sensor array also provides an indirect pressure-sensing tactile image.

Further, the array of sensors can be transparent or translucent and can be provided with an underlying visual display element such as an alphanumeric, graphics, or image display. The underlying visual display can comprise, for example, an LED array display, a backlit LCD, etc. Such an underlying display can be used to render geometric boundaries or labels for soft-key functionality implemented with the tactile sensor array, to display status information, etc. Tactile array sensors implemented as transparent touchscreens are taught in the 1999 filings of issued U.S. Pat. No. 6,570,078 and pending U.S. patent application Ser. No. 11/761,978.

In some implementations, the touchpad or touchscreen can comprise a tactile sensor array obtains or provides individual measurements in every enabled cell in the sensor array that provides these as numerical values. The numerical values can be communicated in a numerical data array, as a sequential data stream, or in other ways. When regarded as a numerical data array with row and column ordering that can be associated with the geometric layout of the individual cells of the sensor array, the numerical data array can be regarded as representing a tactile image. The only tactile sensor array requirement to obtain the full functionality of a touch-based user interface is that the tactile sensor array produce a multi-level gradient measurement image as a finger, part of hand, or other pliable object varies is proximity in the immediate area of the sensor surface.

Such a tactile sensor array should not be confused with the “null/contact” touchpad which, in normal operation, acts as a pair of orthogonally responsive potentiometers. These “null/contact” touchpads do not produce pressure images, proximity images, or other image data but rather, in normal operation, two voltages linearly corresponding to the location of a left-right edge and forward-back edge of a single area of contact. Such “null/contact” touchpads, which are universally found in existing laptop computers, are discussed and differentiated from tactile sensor arrays in issued U.S. Pat. No. 6,570,078 and pending U.S. patent application Ser. No. 11/761,978. Before leaving this topic, it is pointed out that these the “null/contact” touchpads nonetheless can be inexpensively adapted with simple analog electronics to provide at least primitive multi-touch capabilities as taught in issued U.S. Pat. No. 6,570,078 and pending U.S. patent application Ser. No. 11/761,978 (pre-grant publication U.S. 2007/0229477 and therein, paragraphs [0022]-[0029], for example).

More specifically, FIG. 4 (adapted from U.S. patent application Ser. No. 12/418,605) illustrates the side view of a finger 401 lightly touching the surface 402 of a tactile sensor array. In this example, the finger 401 contacts the tactile sensor surface in a relatively small area 403. In this situation, on either side the finger curves away from the region of contact 403, where the non-contacting yet proximate portions of the finger grow increasingly far 404a, 405a, 404b, 405b from the surface of the sensor 402. These variations in physical proximity of portions of the finger with respect to the sensor surface should cause each sensor element in the tactile proximity sensor array to provide a corresponding proximity measurement varying responsively to the proximity, separation distance, etc. The tactile proximity sensor array advantageously comprises enough spatial resolution to provide a plurality of sensors within the area occupied by the finger (for example, the area comprising width 406). In this case, as the finger is pressed down, the region of contact 403 grows as the more and more of the pliable surface of the finger conforms to the tactile sensor array surface 402, and the distances 404a, 405a, 404b, 405b contract. If the finger is tilted, for example by rolling in the user viewpoint counterclockwise (which in the depicted end-of-finger viewpoint clockwise 407a) the separation distances on one side of the finger 404a, 405a will contract while the separation distances on one side of the finger 404b, 405b will lengthen. Similarly if the finger is tilted, for example by rolling in the user viewpoint clockwise (which in the depicted end-of-finger viewpoint counterclockwise 407b) the separation distances on the side of the finger 404b, 405b will contract while the separation distances on the side of the finger 404a, 405a will lengthen.

In many various implementations, the tactile sensor array can be connected to interface hardware that sends numerical data responsive to tactile information captured by the tactile sensor array to a processor. In various implementations, this processor will process the data captured by the tactile sensor array and transform it various ways, for example into a collection of simplified data, or into a sequence of tactile image “frames” (this sequence akin to a video stream), or into highly refined information responsive to the position and movement of one or more fingers and other parts of the hand.

As to further detail of the latter example, a “frame” can refer to a 2-dimensional list, number of rows by number of columns, of tactile measurement value of every pixel in a tactile sensor array at a given instance. The time interval between one frame and the next one depends on the frame rate of the system and the number of frames in a unit time (usually frames per second). However, these features are and are not firmly required. For example, in some implementations a tactile sensor array can not be structured as a 2-dimensional array but rather as row-aggregate and column-aggregate measurements (for example row sums and columns sums as in the tactile sensor of year 2003-2006 Apple™ Powerbooks™, row and column interference measurement data as can be provided by a surface acoustic wave or optical transmission modulation sensor as discussed later in the context of FIG. 13, etc.). Additionally, the frame rate can be adaptively-variable rather than fixed, or the frame can be segregated into a plurality regions each of which are scanned in parallel or conditionally (as taught in U.S. Pat. No. 6,570,078 and pending U.S. patent application Ser. No. 12/418,605), etc.

FIG. 5a (adapted from U.S. patent application Ser. No. 12/418,605) depicts a graphical representation of a tactile image produced by contact with the bottom surface of the most outward section (between the end of the finger and the most nearby joint) of a human finger on a tactile sensor array. In this example tactile array, there are 24 rows and 24 columns; other realizations can have fewer, more, or significantly more (hundreds or thousands) of rows and columns. Tactile measurement values of each cell are indicated by the numbers and shading in each cell. Darker cells represent cells with higher tactile measurement values. Similarly, FIG. 5b (also adapted from U.S. patent application Ser. No. 12/418,605) provides a graphical representation of a tactile image produced by contact with multiple human fingers on a tactile sensor array. In other implementations, there can be a larger or smaller number of pixels for a given images size, resulting in varying resolution. Additionally, there can be larger or smaller area with respect to the image size resulting in a greater or lesser potential measurement area for the region of contact to be located in or move about.

FIG. 6 (adapted from U.S. patent application Ser. No. 12/418,605) depicts a realization wherein a tactile sensor array is provided with real-time or near-real-time data acquisition capabilities. The captured data reflects spatially distributed tactile measurements (such as pressure, proximity, etc.). The tactile sensory array and data acquisition stage provides this real-time or near-real-time tactile measurement data to a specialized image processing arrangement for the production of parameters, rates of change of those parameters, and symbols responsive to aspects of the hand's relationship with the tactile or other type of sensor array. In some applications, these measurements can be used directly. In other situations, the real-time or near-real-time derived parameters can be directed to mathematical mappings (such as scaling, offset, and nonlinear warpings) in real-time or near-real-time into real-time or near-real-time application-specific parameters or other representations useful for applications. In some implementations, general purpose outputs can be assigned to variables defined or expected by the application.

The tactile sensor array employed by touch-based user interface technologies can be implemented by a wide variety of means, for example:
Pressure sensor arrays (implemented by for example—although not limited to—one or more of resistive, capacitive, piezo, optical, acoustic, or other sensing elements);
Pressure sensor arrays (implemented by for example—although not limited to—one or more of resistive, capacitive, piezo, optical, acoustic, or other sensing elements);
Proximity sensor arrays (implemented by for example—although not limited to—one or more of capacitive, optical, acoustic, or other sensing elements);
Surface-contact sensor arrays (implemented by for example—although not limited to—one or more of resistive, capacitive, piezo, optical, acoustic, or other sensing elements).

Below a few specific examples of the above are provided by way of illustration; however these are by no means limiting. The examples include:
Pressure sensor arrays comprising arrays of isolated sensors (FIG. 7);
Capacitive proximity sensors (FIG. 8);
Multiplexed LED optical reflective proximity sensors (FIG. 9);
Video camera optical reflective sensing (as taught in U.S. Pat. No. 6,570,078 and U.S. patent application Ser. Nos. 10/683,915 and 11/761,978):
   direct image of hand (FIGS. 10a-10c);
   image of deformation of material (FIG. 11);
Surface contract refraction/absorption (FIG. 12).

An example implementation of a tactile sensor array is a pressure sensor array. Pressure sensor arrays discussed in U.S. Pat. No. 6,570,078 and pending U.S. patent application Ser. No. 11/761,978. FIG. 7 depicts a pressure sensor array arrangement comprising a rectangular array of isolated individual two-terminal pressure sensor elements. Such two-terminal pressure sensor elements typically operate by measuring changes in electrical (resistive, capacitive) or optical properties of an elastic material as the material is compressed. In typical implementation, each sensor element in the sensor array can be individually accessed via multiplexing arrangement, for example as shown in FIG. 7, although other arrangements are possible and provided for by the invention. Examples of prominent manufacturers and suppliers of pressure sensor arrays include Tekscan™, Inc. (307 West First Street., South Boston, Mass., 02127, www.tekscan.com), Pressure Profile Systems™ (5757 Century Boulevard, Suite 600, Los Angeles, Calif. 90045, www.pressureprofile.com), Sensor Products™, Inc. (300 Madison Avenue, Madison, N.J. 07940 USA, www.sensorprod.com), and Xsensor™ Technology Corporation (Suite 111, 319-2nd Ave SW, Calgary, Alberta T2P 0C5, Canada, www.xsensor.com).

The capacitive touch sensors described above involve a capacitance change due to spatial compression of capacitive elements; there is no direct RF or electrostatic sensing of the finger itself, and the result is typically pressure sensing. Most capacitive touch sensors, however, do involve direct RF or electrostatic sensing of the finger itself, typically resulting in proximity sensing. It is also possible to create capacitive sensor arrays responsive to both proximity and pressure, for example such as the capacitive sensor arrays taught in U.S. Pat. No. 6,323,846 by Westerman.

Capacitive proximity sensors can be used in various handheld devices with touch interfaces (see for example, among many, http://electronics.howstuffworks.com/iphone2.htm, http://www.veritasetvisus.com/VVTP-12,%20Walker.pdf). Prominent manufacturers and suppliers of such sensors, both in the form of opaque touchpads and transparent touch screens, include Balda AG (Bergkirchener Str. 228, 32549 Bad Oeynhausen, DE, www.balda.de), Cypress™ (198 Champion Ct., San Jose, Calif. 95134, www.cypress.com), and Synaptics™ (2381 Bering Dr., San Jose, Calif. 95131, www.synaptics.com). In such sensors, the region of finger contact is detected by variations in localized capacitance resulting from capacitive proximity effects induced by an overlapping or otherwise nearly-adjacent finger. More specifically, the electrical field at the intersection of orthogonally-aligned conductive buses is influenced by the vertical distance or gap between the surface of the sensor array and the skin surface of the finger. Such capacitive proximity sensor technology is low-cost, reliable, long-life, stable, and can readily be made transparent. FIG. 8 (adapted from http://www.veritasetvisus.com/VVTP-12,%20Walker.pdf with slightly more functional detail added) shows a popularly accepted view of a typical cell phone or PDA capacitive proximity sensor implementation. Capacitive sensor arrays of this type can be highly susceptible to noise and various shielding and noise-suppression electronics and systems techniques can need to be employed for adequate stability, reliability, and performance in various electric field and electromagnetically-noisy environments. In some implementations of a touch-based user interface, the present invention can use the same spatial resolution as current capacitive proximity touchscreen sensor arrays. In other implementations, a higher spatial resolution is advantageous.

Forrest M. Mims is credited as showing that an LED can be used as a light detector as well as a light emitter. Recently, light-emitting diodes have been used as a tactile proximity sensor array (for example, as taught in U.S. Pat. No. 7,598,949 by Han and depicted in the associated video available at http://cs.nyu.edu/˜jhan/ledtouch/index.html). Such tactile proximity array implementations typically need to be operated in a darkened environment (as seen in the video in the above web link). In one implementation, each LED in an array of LEDs can be used as a photodetector as well as a light emitter, although a single LED can either transmit or receive information at one time. Each LED in the array can sequentially be selected to be set to be in receiving mode while others adjacent to it are placed in light emitting mode. A particular LED in receiving mode can pick up reflected light from the finger, provided by said neighboring illuminating-mode LEDs. FIG. 9 depicts an implementation. The invention provides for additional systems and methods for not requiring darkness in the user environment in order to operate the LED array as a tactile proximity sensor. In one implementation, potential interference from ambient light in the surrounding user environment can be limited by using an opaque pliable or elastically deformable surface covering the LED array that is appropriately reflective (directionally, amorphously, etc. as can be advantageous in a particular design) on the side facing the LED array. Such a system and method can be readily implemented in a wide variety of ways as is clear to one skilled in the art. In another implementation, potential interference from ambient light in the surrounding user environment can be limited by employing amplitude, phase, or pulse width modulated circuitry or software to control the underlying light emission and receiving process. For example, in an implementation the LED array can be configured to emit modulated light modulated at a particular carrier frequency or variational waveform and respond to only modulated light signal components extracted from the received light signals comprising that same carrier frequency or variational waveform. Such a system and method can be readily implemented in a wide variety of ways as is clear to one skilled in the art.

An important special case of this is the use of OLED arrays such as those used in OLED displays increasingly deployed in cellphones, smartphones, and Personal Digital Assistants (“PDAs”) manufactured by Samsung, Nokia, LG, HTC, Phillips, Sony and others. As taught in pending U.S. patent application Ser. Nos. 13/452,461, 13/180,345 and 13/547,024, such an arrangement can be implemented in a number of ways to provide a high-resolution optical tactile sensor for touch-based user interfaces. Color OLED array displays are of particular interest, in general and as pertaining to the present invention, because:
They can be fabricated (along with associated electrical wiring conductors) via printed electronics on a wide variety of surfaces such as glass, Mylar, plastics, paper, etc.;
Leveraging some such surface materials, they can be readily bent, printed on curved surfaces, etc.;
They can be transparent (and be interconnected with transparent conductors);
Leveraging such transparency, they can be:
   Stacked vertically,
   Used as an overlay element atop an LCD or other display,
   Used as an underlay element between an LCD and its associated backlight.
      As taught in U.S. Pat. No. 8,125,559 and pending U.S. patent application Ser. Nos. 13/452,461, 13/180,345 and 13/547,024, leveraging this in various ways, in accordance with implementations, array of inorganic-LEDs, OLEDs, or related optoelectronic devices is configured to perform functions of two or more of:
a visual image display (graphics, image, video, GUI, etc.),
a (lensless imaging) camera (as taught in U.S. Pat. Nos. 8,284,290 and 8,305,480,
a tactile user interface (touch screen),
a proximate gesture user interface.
   As taught in pending U.S. patent application Ser. Nos. 13/452,461, 13/180,345 and 13/547,024, such arrangements further advantageously allow for a common processor to be used for both a display and a touch-based user interface. Further, the now widely-popular RF capacitive matrix arrangements used in contemporary multi-touch touchscreen is fully replaced with an arrangement involving far fewer electronic components.

Another type of optical tactile sensor approach arranged to serve as both a display and a tactile sensor is taught in U.S. Pat. No. 8,049,739 by Wu et al., which uses a deformable back-lit LCD display comprising internally reflective elements and photosensitive elements associated with the LCD display responsive to the reflective light.

Use of video cameras for gathering control information from the human hand in various ways is discussed in U.S. Pat. No. 6,570,078 and Pending U.S. patent application Ser. No. 10/683,915. Here the camera image array is employed as a touch-based user interface tactile sensor array. Images of the human hand as captured by video cameras can be used as an enhanced multiple-parameter interface responsive to hand positions and gestures, for example as taught in U.S. patent application Ser. No. 10/683,915 Pre-Grant-Publication 2004/0118268 (paragraphs [314], [321]-[332], [411], [653], both stand-alone and in view of [325], as well as [241]-[263]). FIGS. 10a and 10b depict single camera implementations. As taught in section 2.1.7.2 of U.S. Pat. No. 6,570,078, pending U.S. patent application Ser. No. 10/683,915, U.S. patent application Ser. No. 13/706,214, two or more video cameras can be used in orthogonal or stereoscopic arrangements to capture hand expressions within 3-space regions. FIG. 10c depicts a two camera implementation. As taught in the aforementioned references, a wide range of relative camera sizes and positions with respect to the hand are provided for, considerably generalizing the arrangements shown in FIGS. 10a-10c.

In another video camera tactile controller implementation, a flat or curved transparent or translucent surface or panel can be used as sensor surface. When a finger is placed on the transparent or translucent surface or panel, light applied to the opposite side of the surface or panel reflects light in a distinctly different manner than in other regions where there is no finger or other tactile contact. The image captured by an associated video camera will provide gradient information responsive to the contact and proximity of the finger with respect to the surface of the translucent panel. For example, the parts of the finger that are in contact with the surface will provide the greatest degree of reflection while parts of the finger that curve away from the surface of the sensor provide less reflection of the light. Gradients of the reflected light captured by the video camera can be arranged to produce a gradient image that appears similar to the multilevel quantized image captured by a pressure sensor. By comparing changes in gradient, changes in the position of the finger and pressure applied by the finger can be detected. FIG. 11 depicts an implementation.

FIGS. 12a-12b depict an implementation of an arrangement comprising a video camera capturing the image of a deformable material whose image varies according to applied pressure. In the example of FIG. 12a, the deformable material serving as a touch interface surface can be such that its intrinsic optical properties change in response to deformations, for example by changing color, index of refraction, degree of reflectivity, etc. In another approach, the deformable material can be such that exogenous optic phenomena are modulated in response to the deformation. As an example, the arrangement of FIG. 12b is such that the opposite side of the deformable material serving as a touch interface surface comprises deformable bumps which flatten out against the rigid surface of a transparent or translucent surface or panel. The diameter of the image as seen from the opposite side of the transparent or translucent surface or panel increases as the localized pressure from the region of hand contact increases. Such an approach was created by Professor Richard M. White at U.C. Berkeley in the 1980's.

FIG. 13 depicts an optical or acoustic diffraction or absorption arrangement that can be used for contact or pressure sensing of tactile contact. Such a system can employ, for example light or acoustic waves. In this class of methods and systems, contact with or pressure applied onto the touch surface causes disturbances (diffraction, absorption, reflection, etc.) that can be sensed in various ways. The light or acoustic waves can travel within a medium comprised by or in mechanical communication with the touch surface. A slight variation of this is where surface acoustic waves travel along the surface of, or interface with, a medium comprised by or in mechanical communication with the touch surface.

Compensation for Non-Ideal Behavior of Tactile Sensor Arrays

Individual sensor elements in a tactile sensor array produce measurements that vary sensor-by-sensor when presented with the same stimulus. Inherent statistical averaging of the algorithmic mathematics can damp out much of this, but for small image sizes (for example, as rendered by a small finger or light contact), as well as in cases where there are extremely large variances in sensor element behavior from sensor to sensor, the invention provides for each sensor to be individually calibrated in implementations where that can be advantageous. Sensor-by-sensor measurement value scaling, offset, and nonlinear warpings can be invoked for all or selected sensor elements during data acquisition scans. Similarly, the invention provides for individual noisy or defective sensors can be tagged for omission during data acquisition scans.

FIG. 14 shows a finger image wherein rather than a smooth gradient in pressure or proximity values there is radical variation due to non-uniformities in offset and scaling terms among the sensors.

FIG. 15 shows a sensor-by-sensor compensation arrangement for such a situation. A structured measurement process applies a series of known mechanical stimulus values (for example uniform applied pressure, uniform simulated proximity, etc.) to the tactile sensor array and measurements are made for each sensor. Each measurement data point for each sensor is compared to what the sensor should read and a piecewise-linear correction is computed. In an implementation, the coefficients of a piecewise-linear correction operation for each sensor element are stored in a file. As the raw data stream is acquired from the tactile sensor array, sensor-by-sensor the corresponding piecewise-linear correction coefficients are obtained from the file and used to invoke a piecewise-linear correction operation for each sensor measurement. The value resulting from this time-multiplexed series of piecewise-linear correction operations forms an outgoing “compensated” measurement data stream. Such an arrangement is employed, for example, as part of the aforementioned Tekscan™ resistive pressure sensor array products.

Additionally, the macroscopic arrangement of sensor elements can introduce nonlinear spatial warping effects. As an example, various manufacturer implementations of capacitive proximity sensor arrays and associated interface electronics are known to comprise often dramatic nonlinear spatial warping effects. FIG. 16 (adapted from http://labs.moto.com/diy-touchscreen-analysis/) depicts the comparative performance of a group of contemporary handheld devices wherein straight lines were entered using the surface of the respective touchscreens. A common drawing program was used on each device, with widely-varying type and degrees of nonlinear spatial warping effects clearly resulting. For simple gestures such as selections, finger-flicks, drags, spreads, etc., such nonlinear spatial warping effects introduce little consequence. For more precision applications, such nonlinear spatial warping effects introduce unacceptable performance. Close study of FIG. 16 shows different types of responses to tactile stimulus in the direct neighborhood of the relatively widely-spaced capacitive sensing nodes versus tactile stimulus in the boundary regions between capacitive sensing nodes. Increasing the number of capacitive sensing nodes per unit area can reduce this, as can adjustments to the geometry of the capacitive sensing node conductors. In many cases improved performance can be obtained by introducing or more carefully implementing interpolation mathematics.

### Overview of 3D, 6D, and Related Capabilities of HDTP Technology User Interface Technology

Some implementations of HDTP technology are provided. This will be followed by a summarizing overview of HDTP technology. With the exception of a few minor variations and examples, the material presented in this overview section is draw from U.S. Pat. No. 6,570,078, pending U.S. patent application Ser. Nos. 11/761,978, 12/418,605, 12/502,230, 12/541,948, 12/724,413, 13/026,248, and related pending U.S. patent applications and is accordingly attributed to the associated inventors.

FIGS. 17a-17f (adapted from U.S. patent application Ser. No. 12/418,605 and described in U.S. Pat. No. 6,570,078) illustrate six independently adjustable degrees of freedom of touch from a single finger that can be simultaneously measured by the HDTP technology. The depiction in these figures is from the side of the touchpad. FIGS. 17a-17c show actions of positional change (amounting to applied pressure in the case of FIG. 17c) while FIGS. 17d-17f show actions of angular change. Each of these can be used to control a user interface parameter, allowing the touch of a single fingertip to control up to six simultaneously-adjustable quantities in an interactive user interface as shown in FIG. 18.

Each of the six parameters listed above can be obtained from operations on a collection of sums involving the geometric location and tactile measurement value of each tactile measurement sensor. Of the six parameters, the left-right geometric center, forward-back geometric center, and clockwise-counterclockwise yaw rotation can be obtained from binary threshold image data. The average downward pressure, roll, and pitch parameters are in some implementations beneficially calculated from gradient (multi-level) image data. One remark is that because binary threshold image data is sufficient for the left-right geometric center, forward-back geometric center, and clockwise-counterclockwise yaw rotation parameters, these also can be discerned for flat regions of rigid non-pliable objects, and thus the HDTP technology thus can be adapted to discern these three parameters from flat regions with striations or indentations of rigid non-pliable objects.

Additionally, as taught in U.S. Pat. No. 6,570,078 and pending U.S. patent application Ser. Nos. 11/761,978 and 12/418,605, a wide range of richly-parameterized multi-touch configurations are supported by the HDTP technology. FIG. 19 depicts example multi-touch positions and gestures involving two fingers that are supported by the HDTP technology, and FIG. 20 depicts various individual and compound images associated with touch by various portions of the human hand whose recognition and classification are supported by the HDTP technology.

### BRIEF DESCRIPTION OF THE DRAWINGS

The above and other aspects, features and advantages of the present invention will become more apparent upon consideration of the following description of preferred embodiments taken in conjunction with the accompanying drawing figures.

FIGS. 1a-1g depict a number of arrangements and embodiments employing touch-based user interface technologies.

FIGS. 2a-2e and FIGS. 3a-3b depict various integrations of an HDTP into the back of a conventional computer mouse as taught in U.S. Pat. No. 7,557,797 and in pending U.S. patent application Ser. No. 12/619,678.

FIG. 4 illustrates the side view of a finger lightly touching the surface of a tactile sensor array.

FIG. 5a is a graphical representation of a tactile image produced by contact of a human finger on a tactile sensor array. FIG. 5b provides a graphical representation of a tactile image produced by contact with multiple human fingers on a tactile sensor array.

FIG. 6 depicts a signal flow in an example touch-based user interface implementation.

FIG. 7 depicts a pressure sensor array arrangement.

FIG. 8 depicts a popularly accepted view of a typical cell phone or PDA capacitive proximity sensor implementation.

FIG. 9 depicts an implementation of a multiplexed LED array acting as a reflective optical proximity sensing array.

FIGS. 10a-10c depict camera implementations for direct viewing of at least portions of the human hand, wherein the camera image array is employed as an touch-based user interface tactile sensor array.

FIG. 11 depicts an embodiment of an arrangement comprising a video camera capturing the image of the contact of parts of the hand with a transparent or translucent surface.

FIGS. 12a-12b depict an implementation of an arrangement comprising a video camera capturing the image of a deformable material whose image varies according to applied pressure.

FIG. 13 depicts an implementation of an optical or acoustic diffraction or absorption arrangement that can be used for contact or pressure sensing of tactile contact.

FIG. 14 shows a finger image wherein rather than a smooth gradient in pressure or proximity values there is radical variation due to non-uniformities in offset and scaling terms among the sensors.

FIG. 15 shows a sensor-by-sensor compensation arrangement.

FIG. 16 (adapted from http://labs.moto.com/diy-touchscreen-analysis/) depicts the comparative performance of a group of contemporary handheld devices wherein straight lines were entered using the surface of the respective touchscreens.

FIGS. 17a-17f illustrate six example independently adjustable degrees of freedom of touch from a single finger that can be simultaneously measured by the HDTP technology.

FIG. 18 suggests general ways in which two or more of these independently adjustable degrees of freedom adjusted at once as can be measured by the HDTP technology.

FIG. 19 demonstrates a few two-finger multi-touch postures or gestures from the many that can be recognized by HTDP technology.

FIG. 20 illustrates the pressure profiles for a number of example hand contacts with a tactile-sensor array as can be recognized by the HDTP technology.

FIG. 21 illustrates an example arrangement wherein a spherical touch and/or display surface device is employed as a traditional rotating trackball according to an embodiment of the invention.

FIG. 22 illustrates an example arrangement wherein a spherical touch and/or display surface device is employed as a moderate-size sphere supported by a saddle base according to an embodiment of the invention.

FIG. 23a illustrates an example arrangement wherein a spherical touch and/or display surface device is employed as a larger-size sphere supported by a saddle base according to an embodiment of the invention.

FIG. 23b illustrates an example arrangement according to an embodiment of the invention wherein a spherical touch and/or display surface device is employed as a larger-size sphere that is connectively supported by an arc-and-pin mount as used in geographic globes used to represent the Earth, Moon, planets, and planetary moons.

FIG. 23c illustrates an example arrangement according to an embodiment of the invention wherein a spherical touch and/or display surface device is employed as a larger-size sphere that is magnetically supported wherein the sphere rotates around a vertically-aligned axis.

FIG. 23d illustrates an example arrangement according to an embodiment of the invention wherein a spherical touch and/or display surface device is employed as a larger-size sphere that is connectively supported by an arc-and-pin mount in a manner wherein the sphere rotates around a horizontally-aligned axis.

FIG. 24 illustrates an example arrangement according to an embodiment of the invention wherein a spherical touch and display surface device produces received user interface signals responsive to user tactile proximity contact and/or user tactile proximity, and further produces a visually displayed image responsive to received display signals.

FIG. 25 illustrates an example arrangement according to an embodiment of the invention wherein a spherical touch and display surface device produces received user interface signals responsive to user tactile proximity contact and/or user tactile proximity, and optionally or in a selected modality produces a visually displayed image responsive to received display signals.

FIG. 26 illustrates an example arrangement according to an embodiment of the invention wherein a spherical touch and display surface device produces a visually displayed image responsive to received display signals, and optionally or in a selected modality produces received user interface signals responsive to user tactile proximity contact and/or user tactile proximity.

FIG. 27 illustrates an example arrangement according to an embodiment of the invention wherein a spherical touch and display surface device produces received user interface signals responsive to user tactile proximity contact and/or user tactile proximity.

FIG. 28 illustrates an example arrangement according to an embodiment of the invention wherein a spherical touch and display surface device produces a visually displayed image responsive to received display signals.

FIG. 29 illustrates an example spherical touch sensing surface device wherein a first plurality of ring-shaped electrodes are vertically distributed over or beneath the spherical shape of the touch surface device and a second plurality of ring-shaped electrodes are horizontally distributed over the spherical shape of the touch surface. Such an arrangement can be used when at a given moment a known half of the sphere is unavailable for tactile or proximity contact.

FIG. 30 illustrates an example modification of the arrangement depicted in FIG. 29 wherein each of the electrodes of FIG. 29 have been split into electrically distinct sections.

FIG. 31 illustrates an example spherical touch sensing surface wherein a plurality of LEDs are distributed beneath the spherical shape of the touch surface. In an embodiment, the plurality of LEDs can comprise a plurality of OLEDs.

FIG. 32a illustrates an example two-state state transition diagram for the operating mode of a selected LED.

FIG. 32b illustrates an example three-state state transition diagram for the operating mode of a selected LED.

FIG. 32c illustrates another example three-state state transition diagram for the operating mode of a selected LED.

FIG. 32d illustrates an example four-state state transition diagram for the operating mode of a selected LED.

FIG. 33 illustrates an example two-mode mode transition diagram for the operating mode of selected elements of the spherical touch and/or display surface device is determined by whether or not that element is in a region exposed to user finger touch or proximity.

FIG. 34 illustrates an example expansion of the arrangement of FIG. 33 wherein at least a region of the sphere that is not exposed to user finger touch or proximity is used for the transmission of user interface signals and/or the receiving of display signals.

FIG. 35 illustrates an example one-way data transmission arrangement wherein data signals are transmitted from the spherical touch surface device to an associated mounting, saddle, or base-station.

FIG. 36 illustrates an example one-way data reception arrangement wherein data signals are received by the spherical touch surface device from an associated mounting, saddle, or base-station.

FIG. 37 illustrates an example two-way data transmission arrangement wherein data signals are transmitted from the spherical touch and/or display surface device to an associated mounting, saddle, or base-station and data signals are received by the spherical touch and/or display surface device from an associated mounting, saddle, or base-station.

FIG. 38 illustrates an example inductive powering arrangement employing magnetically-coupled coils.

FIG. 39 illustrates an example optical powering arrangement employing photovoltaic cells or photodiodes.

FIG. 40 illustrates another example optical powering arrangement wherein LEDs or OLEDs beneath the touch surface serve as energy-providing photodiodes for powering internal electronics.

FIG. 41 illustrates an example one-way data reception arrangement wherein data signals are received by the spherical touch surface device from an associated mounting, saddle, or base-station.

FIG. 42 illustrates an example one-way data transmission arrangement wherein data signals are transmitted from the spherical touch surface device to an associated mounting, saddle, or base-station.

FIG. 43 illustrates an example arrangement wherein the arrangement of FIG. 39 is adapted so as to optical transfer data signals received by the spherical touch and/or display surface device with optical powering. In an embodiment, the data signals can be encoded with Manchester or other zero-DC line code.

FIG. 44 illustrates an example arrangement wherein the arrangement of FIG. 40 is adapted so as to optical transfer data signals received by the spherical touch and/or display surface device with optical powering wherein at least some lower-facing LEDs receive data signals.

FIG. 45 illustrates an example arrangement wherein the arrangement of FIG. 40 is adapted so as to optical transfer data signals received by the spherical touch and/or display surface device with optical powering wherein at least some lower-facing LEDs transmit data signals.

FIG. 46 illustrates a system for implementing a user interface comprising a spherically-shaped touch surface according to an embodiment of the invention.

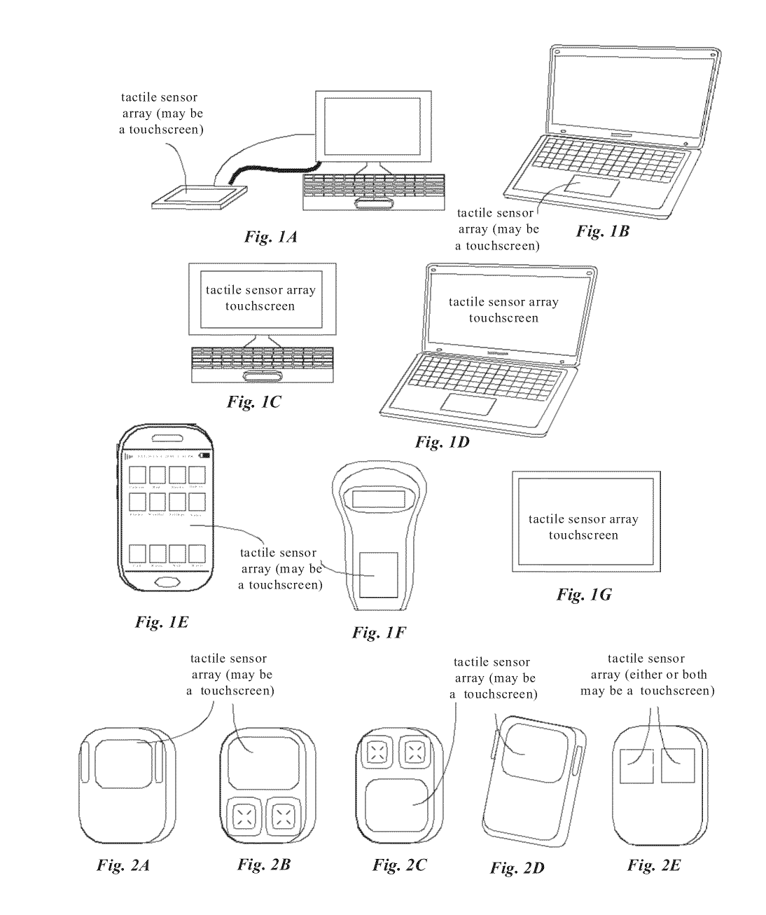

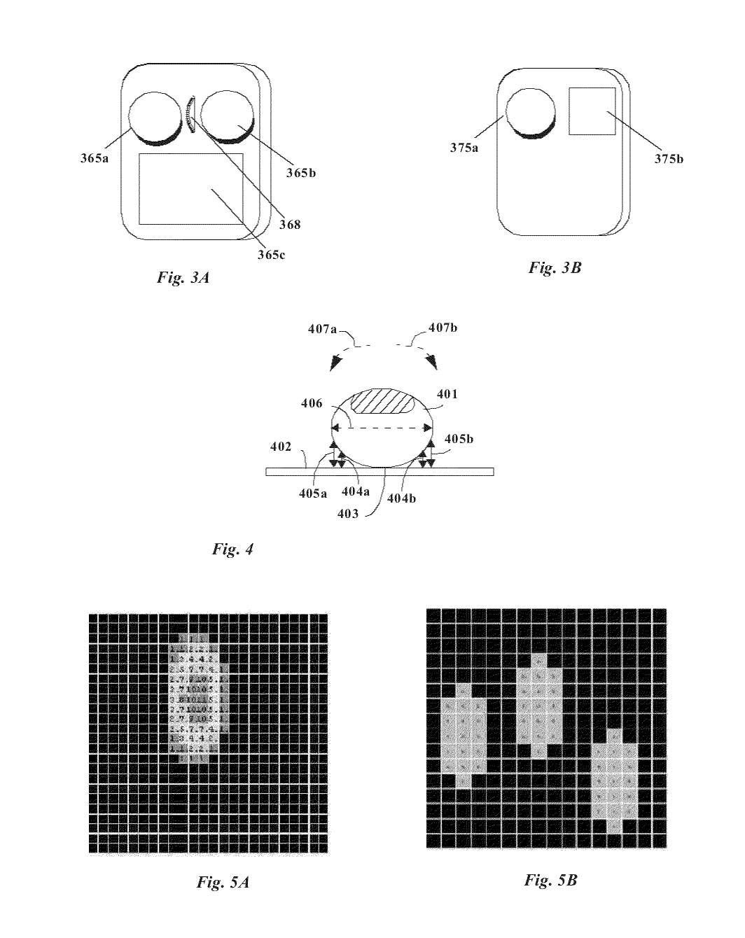

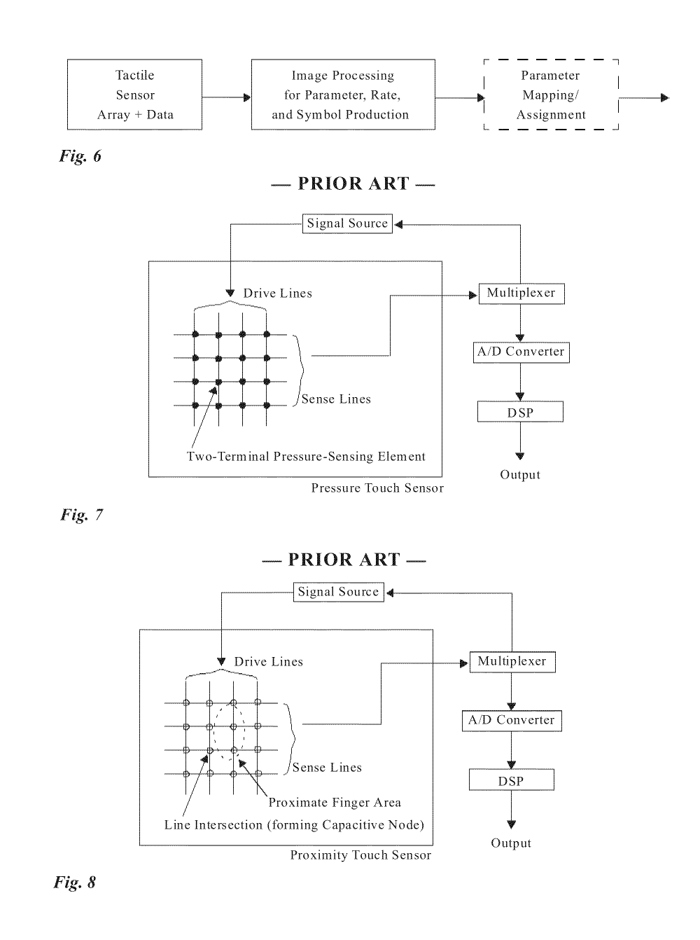

### DETAILED DESCRIPTION OF THE PREFERRED EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In the following description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention.

Despite the many popular touch interfaces and gestures in contemporary information appliances and computers, there remains a wide range of additional control capabilities that can yet be provided by further enhanced user interface technologies. A number of enhanced touch user interface features are described in U.S. Pat. No. 6,570,078, pending U.S. patent application Ser. Nos. 11/761,978, 12/418,605, 12/502,230, 12/541,948, and related pending U.S. patent applications. These patents and patent applications also address popular contemporary gesture and touch features. The enhanced user interface features taught in these patents and patent applications, together with popular contemporary gesture and touch features, can be rendered by the “High Dimensional Touch Pad” (HDTP) technology taught in those patents and patent applications.

Embodiments of the present invention teaches systems and methods for spherical touch and/or display surfaces and user interfaces. In one family of embodiments, a spherical touch surface is implemented. In another family of embodiments, a spherical display surface is implemented. In yet another family of embodiments, a combined a spherical touch and display surface is implemented.

In an embodiment, the spherical surface is the surface of a hollow spherical shell. In an embodiment, the spherical surface is the surface of a non-hollow solid spherical shell. In a manufacturing approach, spherical surfaces can be created by fabricating two partial-spherically-shaped members that are fitted and/or adhered or otherwise joined to create a spherical surface. In an embodiment, the resulting spherical surface is the surface of a hollow spherical shell. In an embodiment, the resulting spherical surface is the surface of a non-hollow solid sphere of material.

In various embodiments, the sphere can be supported in a wide variety of ways, for example by a saddle base, magnetic fields, rod, pins, pedestal, etc. In various embodiments the sphere can be configured as a detached object able to freely rotate, configured to rotate over one or more directions of rotation with respect to a saddle base, or can be configured in a fixed position with respect to the support base so that it is unable to rotate. When configured to rotate, the spherical touch and/or display surface device can be configured to include sensing of at least its angular orientation in a variety of ways including magnetic, image, accelerometer, etc.

In various embodiments, the spherical touch and/or display surface device can be powered in ways including one or more of internal battery, internally generated or harvested power, and external power transferred by magnetic, photoelectric, electrical circuit, etc.

In various embodiments, the spherical touch and/or display surface device can transmit data in a variety of ways including one or more of magnetic, photoelectric, electrical circuit, radio link, etc. In various embodiments, the spherical touch and/or display surface device can receive data in a variety of ways including one or more of magnetic, photoelectric, electrical circuit, radio link, etc. In various embodiments, the spherical touch and/or display surface device can be powered by photoelectric arrangements and also transmit and/or receive data by optical data channels. The data can include tactile measurement signals, user interface signals, timing signals, multiplexing signals, control signals, power management signals, authentication information, and/or other information.

In various embodiments, the spherical touch and/or display surface device can include a variety of touch capabilities including one or more of touch location, multi-touch, simple gesture, etc. These can be recognized by a processor which can then generate user interface signals in response.

In various embodiments, the spherical touch and/or display surface device can include a variety of HDTP touch capabilities including one or more of measurement of more than two touch position parameters, compound gestures, support for generalized gesture capture via “gesteme” (gesture primitives) recognition, gesture grammars, etc. These can be recognized by a processor which can then generate user interface signals in response.

In various embodiments, the spherical touch and/or display surface device can be used in a variety of application settings, for example as a track ball, interactive curved or spherical display, as a geographic globe used to represent the Earth, Moon, planets, and planetary moons, etc.

As example applications, various types of topographical, environmental, meteorological, ecological, demographic, chemical composition, and other types of GIS visual data can be interactively displayed for one or more of the Earth, Moon, planets, and planetary moons. Additionally, various types of views of biological cells, physical devices, and abstract phenomena or data sets can be displayed in a manner that can be physically or virtually rotated and/or manipulated interactively by touch user interface operations.

In an embodiment, the spherical display can be operated in conjunction with various types of active or passive 3D glasses so as to produce 3D imaging on the surface of a spherical display. In one example implementation approach, an OLED device that emits circularly polarized light in the visible light range can be used with circularly polarized glasses. In another example implementation approach, rapidly alternating display of left-eye and right-eye images can be synchronized with rapidly alternating display of left-eye and right-eye shuttering of LCD-shuttered glasses. As example applications for this, various types of 3D views of biological cells, physical devices, and abstract phenomena or data sets can be displayed in a manner that can be physically or virtually rotated and/or manipulated interactively by touch user interface operations. Similarly, various types of 3D views of topographical, environmental, meteorological, ecological, demographic, chemical composition, and other types of GIS visual data can be interactively displayed for one or more of the Earth, Moon, planets, and planetary moons.

In various embodiments, a spherical touch and/or display surface device can be configured in a variety of ways for various applications and application settings, for example as a mechanically free sphere or ball, rotating trackball, interactive curved or spherical display, geographic globe, ornament, “crystal ball,” etc.

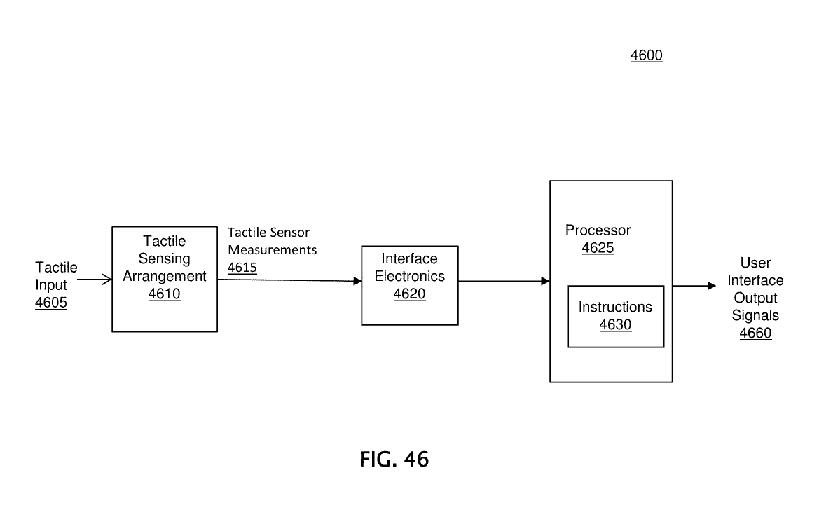

Jumping ahead, FIG. 46 depicts a system 4600 for providing multiple sensor configuration implementations of touch-based user interfaces, including those supporting gestures and HDTP (High-Dimensional Touch Pad) features according to an embodiment of the invention. System 4600 implements a user interface that receives a tactile input 4605, such as by touch contact by at least one finger of a human user. A tactile sensing arrangement 4610 generates tactile sensing measurements 4605 in response to the tactile input 4605 and provides tactile sensing measurements 4605 via interface electronics 4620 to a computational processor 4625. The processor 4625 stores instructions 4630 in memory, which upon execution, use the tactile sensing measurements 4605 to generate user interface output signals 4660.

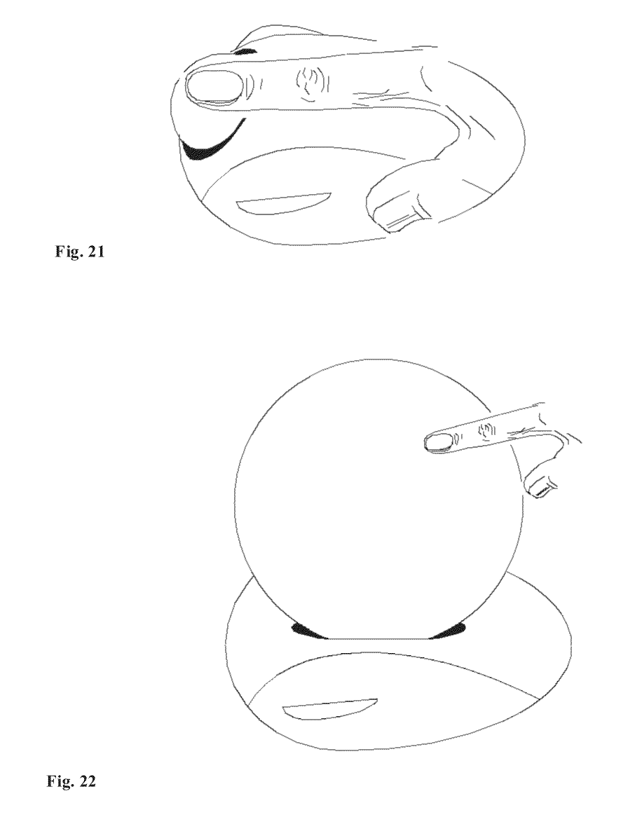

As a first configuration example, FIG. 21 illustrates an example arrangement provided for by embodiments of the invention wherein a spherical touch and/or display surface is employed in place of a traditional rotating trackball.

As another configuration example, FIG. 22 illustrates an example arrangement provided for by embodiments of the invention wherein a spherical touch and/or display surface is employed as a moderate-size sphere supported by a saddle base. In various embodiments the sphere can be configured to rotate over one or more directions of rotation with respect to the saddle base or can be configured in a fixed position with respect to the saddle base so that it is unable to rotate

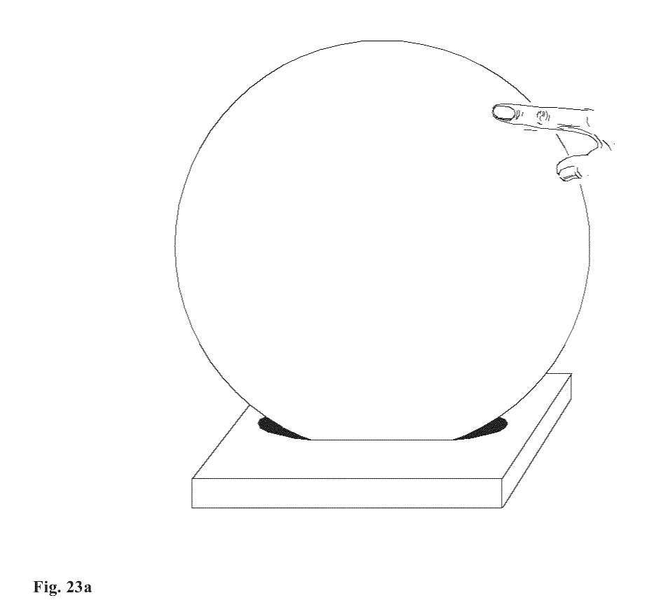

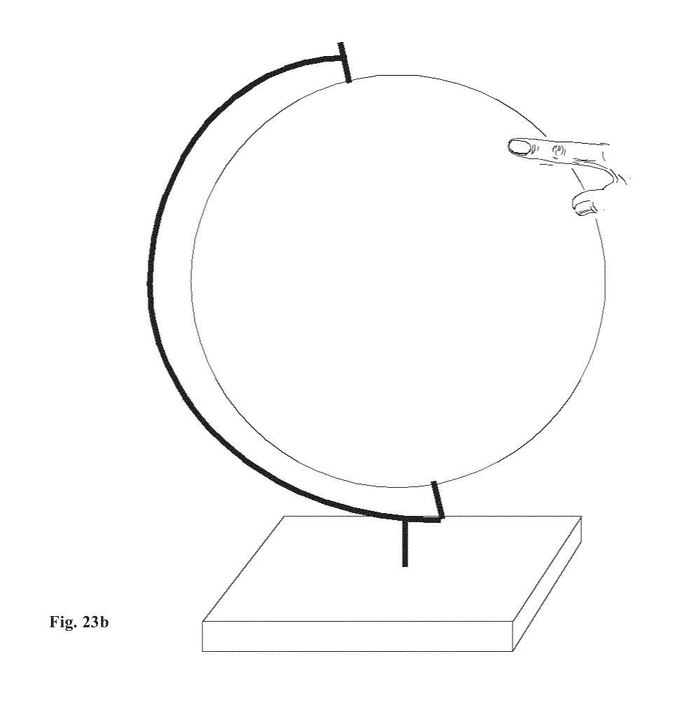

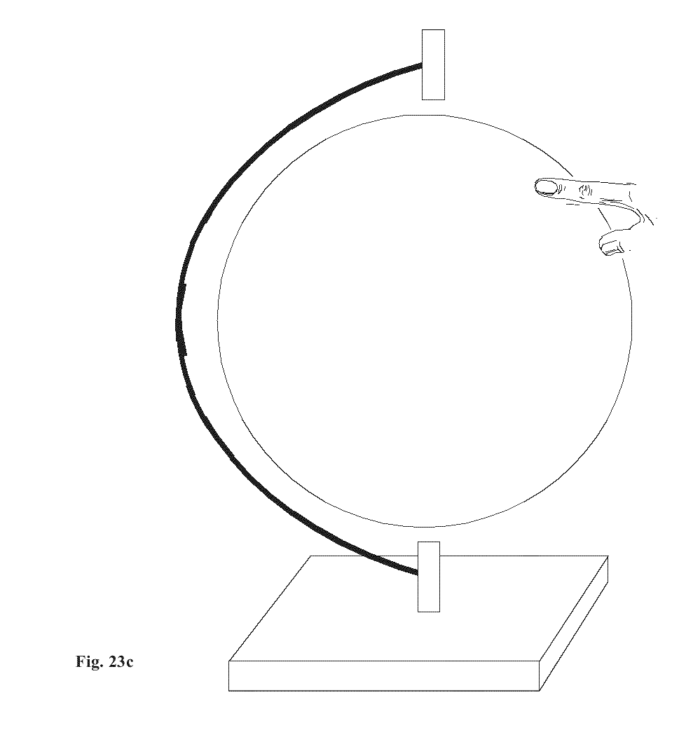

FIG. 23a illustrates an example arrangement provided for by the invention wherein a spherical touch and/or display surface is employed as a larger-size sphere supported by a saddle base. In various embodiments the sphere can be configured to rotate over one or more directions of rotation with respect to the saddle base or can be configured in a fixed position with respect to the saddle base so that it is unable to rotate.

FIG. 23b illustrates an example arrangement provided for by the invention wherein a spherical touch and/or display surface is employed as a larger-size sphere that is connectively supported by an arc-and-pin mount as used in geographic globes used to represent the Earth, Moon, planets, and planetary moons. FIG. 23c illustrates an example arrangement provided for by the invention wherein a spherical touch and/or display surface is employed as a larger-size sphere that is magnetically suspended wherein the sphere rotates around a vertically-aligned axis. FIG. 23d illustrates an example arrangement provided for by the invention wherein a spherical touch and/or display surface is employed as a larger-size sphere that is connectively supported by an arc-and-pin mount in a manner wherein the sphere rotates around a horizontally-aligned axis.

In an embodiment, such an internal surface can comprise elements (such as light emitting elements, structures, markings, etc.) that can be observed through a transparent or translucent touch and/or display surface.

The example arrangements, approaches, implementations, and embodiments described above and in the discussion to follow are merely for illustration and are in no way to be construed as limiting. Numerous other arrangements, approaches, implementations, embodiments, adaptations, variations, and applications are possible and these are anticipated and provided for by the present invention. For example, variations in shape (such as ellipsoid, prolate, oblate, etc.), degree of inclusive enclosure (for example, partially spherical, hemispherical, mounting holes, etc.) source of image (for example, fish-eye camera, 360-degree camera, radar/sonar, biomedical imaging, holographic imaging, abstract mathematical visualization, general data visualization, seismic imaging, telescope, planetarium imaging, etc.), and mounting arrangement (wall portal, ceiling dome, table-top array, etc.) are readily anticipated and provided for by the present invention. In the discussion below, although “spherical touch and/or display surface” terminology is used, it is to be understood that these many other arrangements, approaches, implementations, embodiments, adaptations, variations, and applications are anticipated and provided for by embodiments of the present invention.

### Signal Exchange Between Spherical Touch/Display Surface and Associated Base

Several challenges and opportunities emerge for the transport of signals to and from the spherical touch and/or display surface. These are especially prevalent, for example, when the spherical touch and/or display surface is configured to rotate with one, two, or three degrees of rotational freedom. The invention provides several approaches to these challenges as will be presented in the material to follow this section.

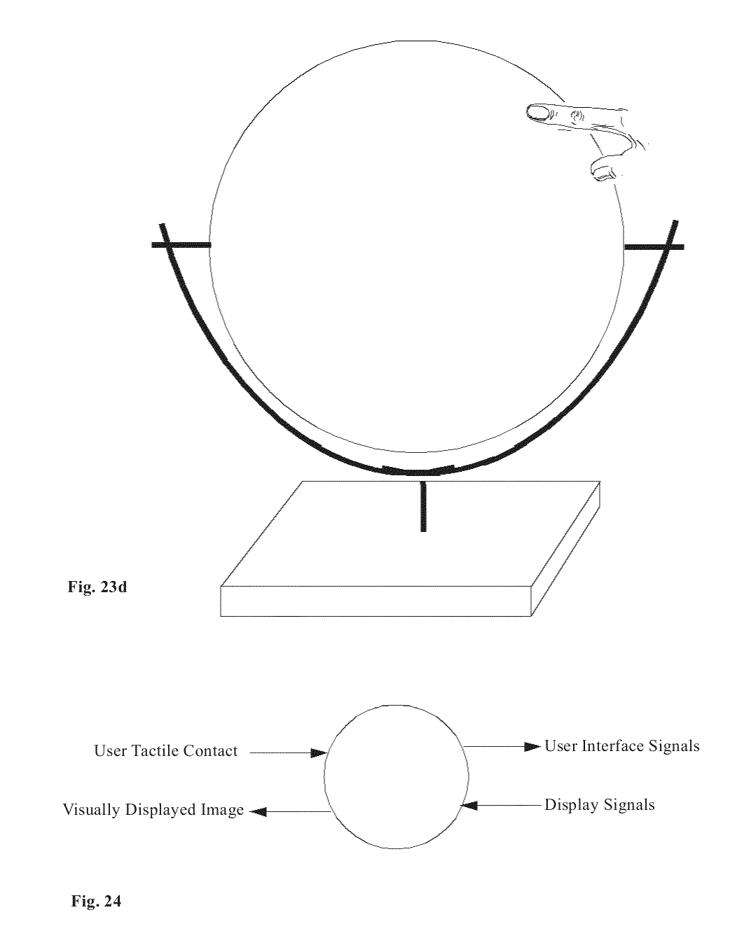

To begin, five example high-level signal flow examples are presented with discussed with reference to FIGS. 24-28. Other arrangements are anticipated and provided for by the present invention.

FIG. 24 illustrates an example arrangement provided for by the invention wherein a spherical touch and display surface produces received user interface signals responsive to user tactile proximity contact and/or user tactile proximity, and further produces a visually displayed image responsive to received display signals.

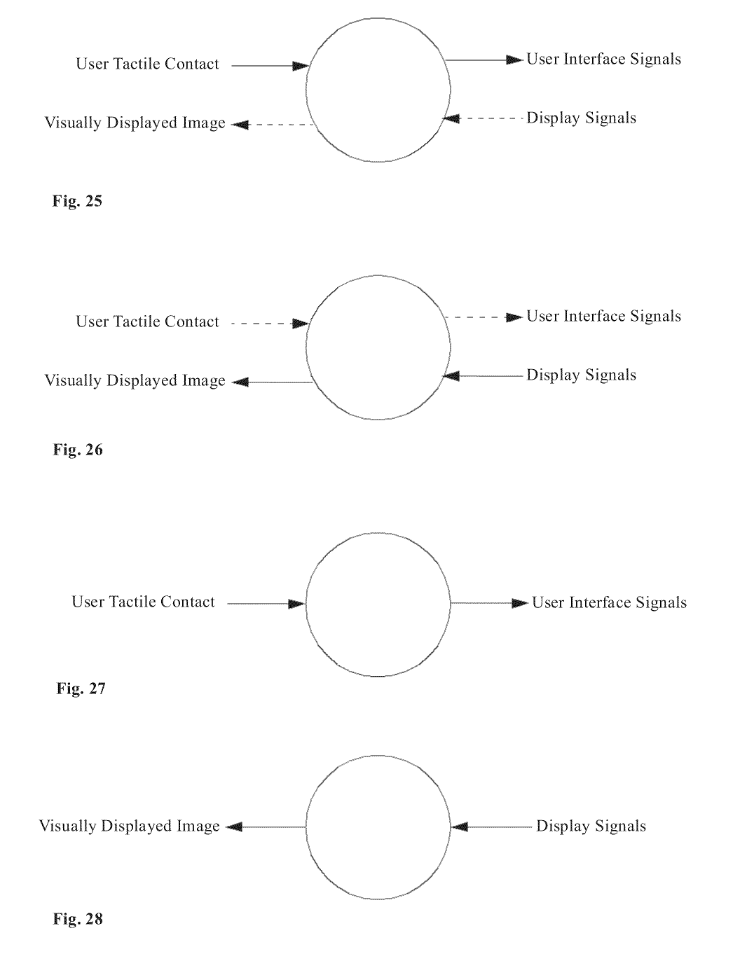

FIG. 25 illustrates an example arrangement provided for by the invention wherein a spherical touch and display surface produces received user interface signals responsive to user tactile proximity contact and/or user tactile proximity, and optionally or in a selected modality produces a visually displayed image responsive to received display signals. FIG. 26 illustrates an example arrangement provided for by the invention wherein a spherical touch and display surface produces a visually displayed image responsive to received display signals, and optionally or in a selected modality produces received user interface signals responsive to user tactile proximity contact and/or user tactile proximity.

FIG. 27 illustrates an example arrangement provided for by the invention wherein a spherical touch and display surface produces received user interface signals responsive to user tactile proximity contact and/or user tactile proximity. FIG. 28 illustrates an example arrangement provided for by the invention wherein a spherical touch and display surface produces a visually displayed image responsive to received display signals.

### Touch/Proximity Sensing for Touch and Gesture Interfacing

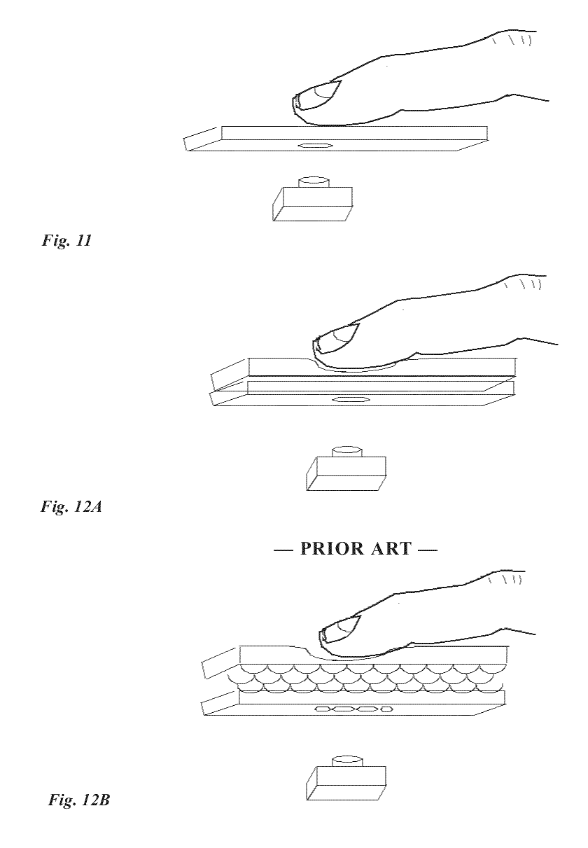

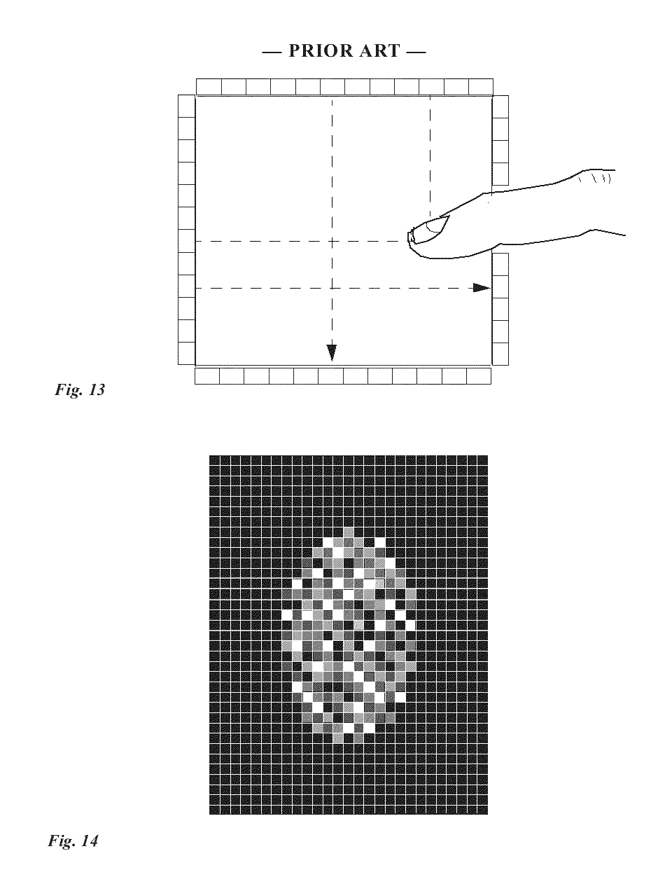

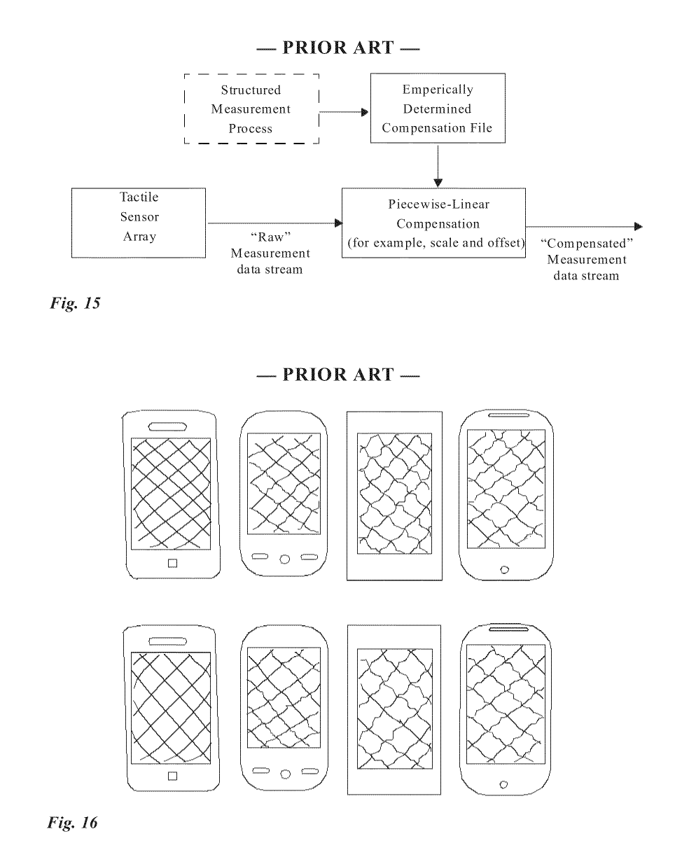

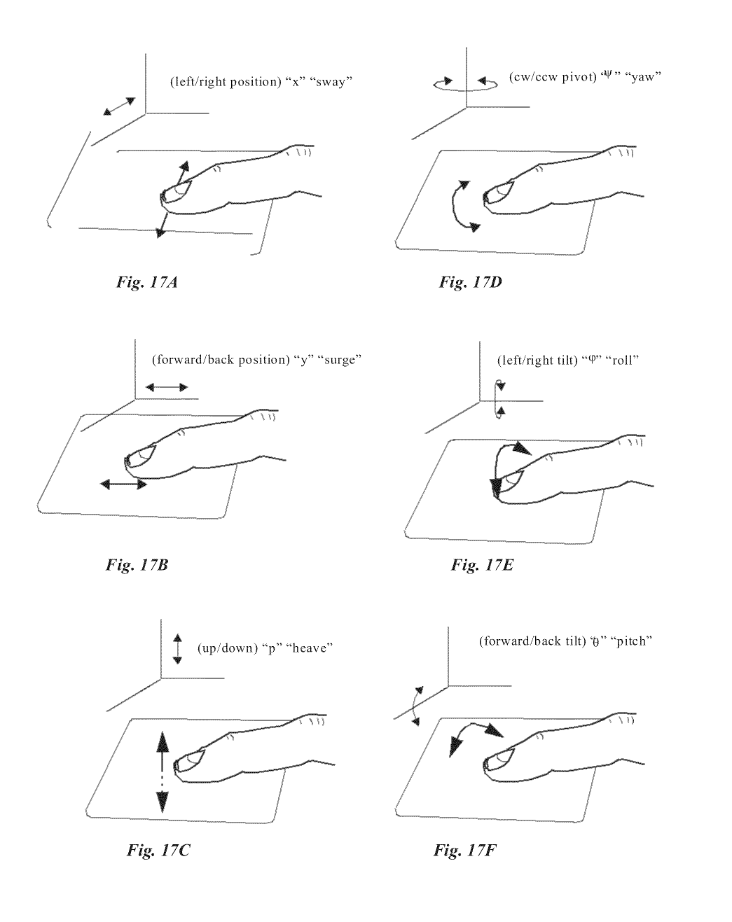

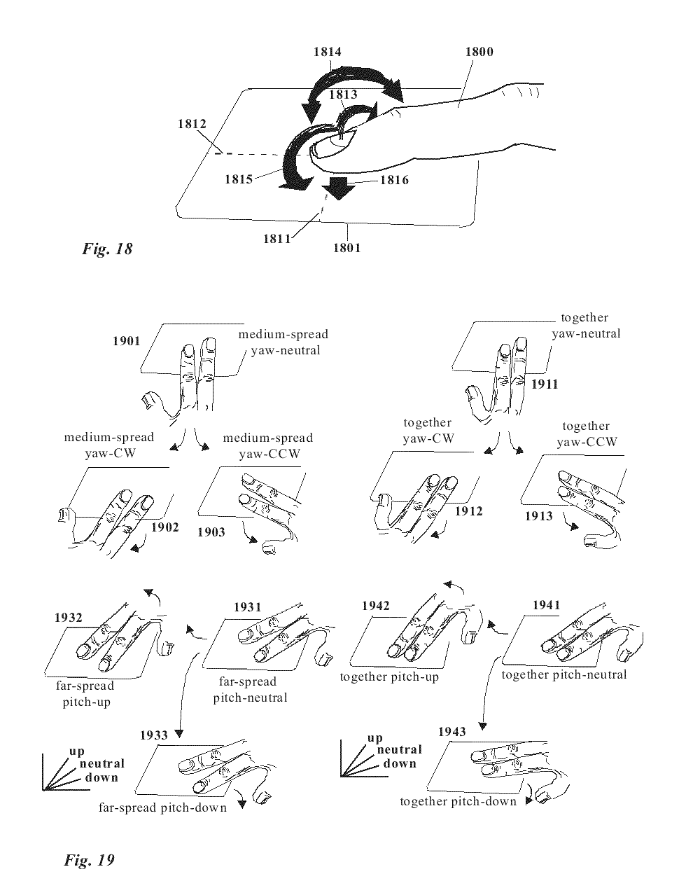

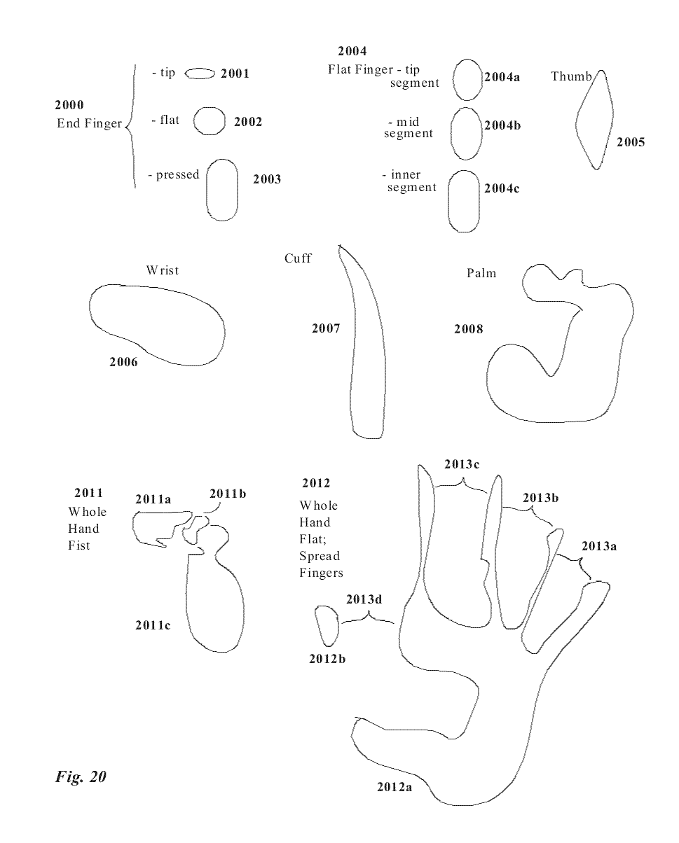

In various embodiments, the spherical touch surface capabilities can be implemented in a variety as ways, for example as described earlier in conjunction with FIGS. 7-9, 10A-10C, 11, and 12A-12B. These include use of pressure sensory arrays, proximity sensor arrays, (transparent, translucent, or opaque) capacitive matrix, (transparent, translucent, or opaque) LED arrays (including OLEDS), one or more video cameras, etc.

When configured or operating as a spherical touch surface, in various embodiments, the spherical touch surface can include a variety of touch capabilities including one or more of touch location, multi-touch, gesture recognition, etc. These can be recognized and/or calculated by a processor which can then generate user interface signals in response.

When configured or operating as a spherical touch surface, in various embodiments the spherical touch surface can include including one or more HDTP touch capabilities such as the simultaneous measurement of more than two touch position parameters, compound gestures, support for generalized gesture capture via “gesteme” (gesture primitives) recognition, gesture grammars, etc. These can be recognized by a processor which can then generate user interface signals in response.

When configured or operating as a spherical touch surface, embodiments can include the recognition of gestures that are specially suited to curved or spherical surfaces, for example gestures that comprise grasping positions and/or motions. These can be recognized by a processor which can then generate user interface signals in response.

### Capacitive Matrix Arrangements for Touch/Proximity Sensing

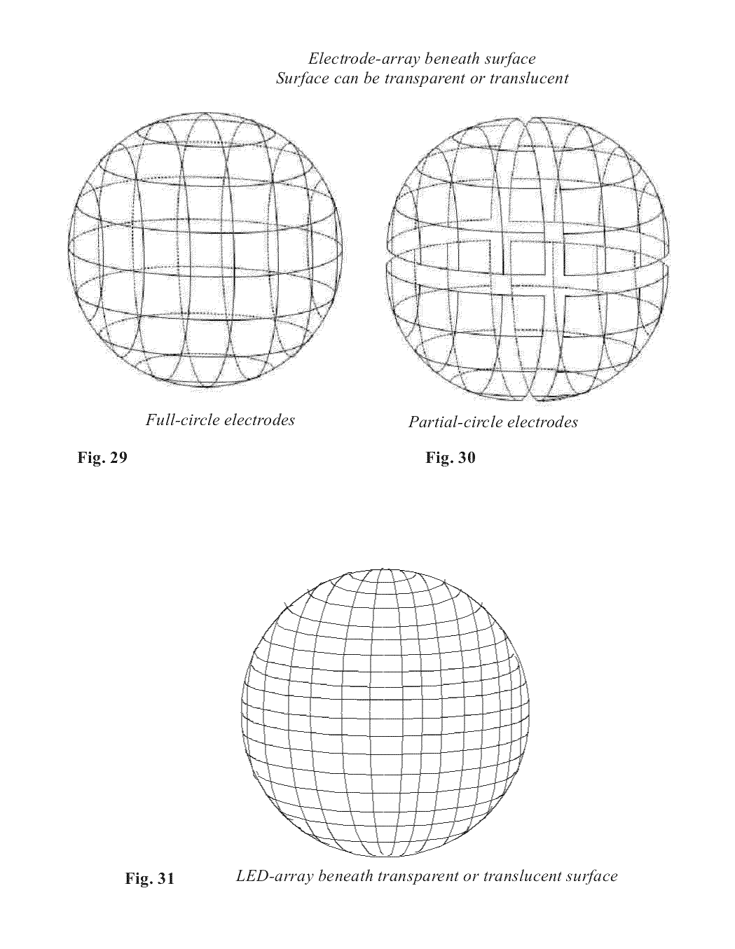

FIG. 29 illustrates an example spherical touch sensing surface wherein a first plurality of ring-shaped electrodes and/or conductors are vertically distributed over or beneath the spherical shape of the touch surface and a second plurality of ring-shaped electrodes are horizontally distributed over the spherical shape of the touch surface. The first plurality of ring-shaped electrodes and/or conductors and the second plurality of ring-shaped electrodes and/or conductors can be separated by an electrically insulating material. Such an arrangement can be used to create capacitive tactile sensing sites at, near, or around the intersections of the paths of first plurality of ring-shaped electrodes and/or conductors and the second plurality of ring-shaped electrodes and/or conductors. Other approaches can be also used. In the described arrangement, note that any one of the ring-shaped electrodes and/or conductors from the first plurality and any one of the ring-shaped electrodes and/or conductors from the second plurality intersect in two locations (as can be seen in the figure). Such an arrangement can be used when at a given moment a known half of the sphere is unavailable for tactile or proximity contact or other arrangements or situations where there is either no ambiguity or some way to otherwise resolve which of the two locations is actually being touched.

In one manufacturing approach, the electrodes and/or conductors can be printed, deposited, adhered, or embedded on the convex side of a curved surface. In another manufacturing approach, the electrodes and/or conductors can be printed, deposited, adhered, or embedded on the concave side of a curved surface. In an embodiment, the electrodes and/or conductors are printed, deposited, adhered, or embedded on the spherical surface a non-hollow solid sphere of material.

To prevent the ambiguity problem described above, as well as for other reasons, it can be advantageous to split the electrode and/or conductor arrangements into separate segments. For example, FIG. 30 illustrates an example modification of the arrangement depicted in FIG. 29 wherein each of the electrodes of FIG. 29 have been split into electrically distinct sections. Other approaches can be also used, for example approaches comprising other segmentation arrangements, geometries, interconnection strategies, etc.

LED and OLED Arrays as Display and/or Touch/Proximity Sensing Elements

Attention is now directed to the use of LED and OLED arrays as display and/or touch/proximity sensing elements. In accordance with embodiments of the invention, array of inorganic-LEDs, OLEDs, or related optoelectronic devices is configured to perform functions of two or more of:
a visual image display (graphics, image, video, GUI, etc.),
a (lensless imaging) camera,
a tactile user interface (touch screen),
a proximate gesture user interface.
   As taught in pending U.S. Patent Application 61/506,634, such arrangements further advantageously allow for a common processor to be used for both a display and a touch-based user interface. Further, the now widely-popular RF capacitive matrix arrangements used in contemporary multi-touch touchscreen is fully replaced with an arrangement involving far fewer electronic components.

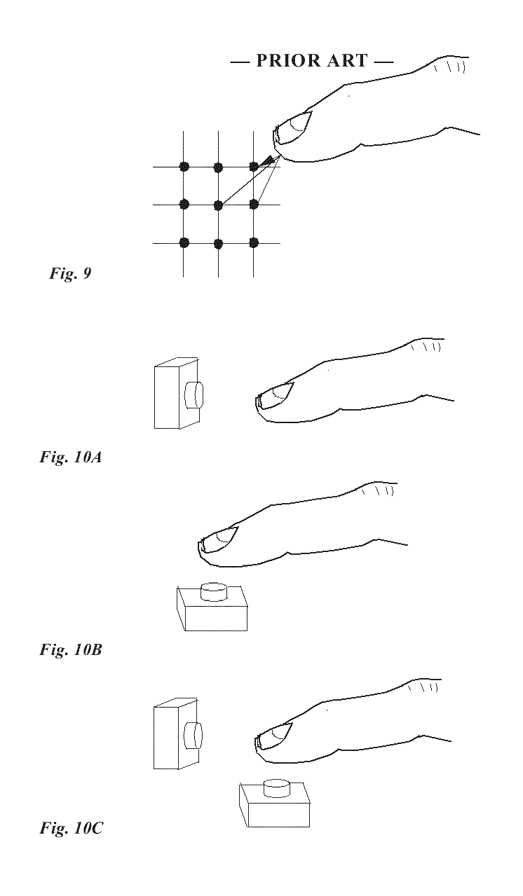

In one embodiment provided for by the invention, each LED in an array of LEDs can be used as a photodetector as well as a light emitter, although a single LED can either transmit or receive information at one time. Each LED in the array can sequentially be selected to be set to be in receiving mode while others adjacent to it are placed in light emitting mode. A particular LED in receiving mode can pick up reflected light from the finger, provided by said neighboring illuminating-mode LEDs. FIG. 9 depicts an implementation. The invention provides for additional systems and methods for not requiring darkness in the user environment in order to operate the LED array as a tactile proximity sensor. In one embodiment, potential interference from ambient light in the surrounding user environment can be limited by using an opaque pliable or elastically deformable surface covering the LED array that is appropriately reflective (directionally, amorphously, etc. as can be advantageous in a particular design) on the side facing the LED array. Such a system and method can be readily implemented in a wide variety of ways as is clear to one skilled in the art. In another embodiment, potential interference from ambient light in the surrounding user environment can be limited by employing amplitude, phase, or pulse width modulated circuitry or software to control the underlying light emission and receiving process. For example, in an implementation the LED array can be configured to emit modulated light modulated at a particular carrier frequency or variational waveform and respond to only modulated light signal components extracted from the received light signals comprising that same carrier frequency or variational waveform. Such a system and method can be readily implemented in a wide variety of ways as is clear to one skilled in the art.

FIG. 31 illustrates an example spherical touch sensing surface wherein a plurality of LEDs are distributed beneath the spherical shape of the touch surface. In an embodiment, the plurality of LEDs can comprise a plurality of OLEDs.

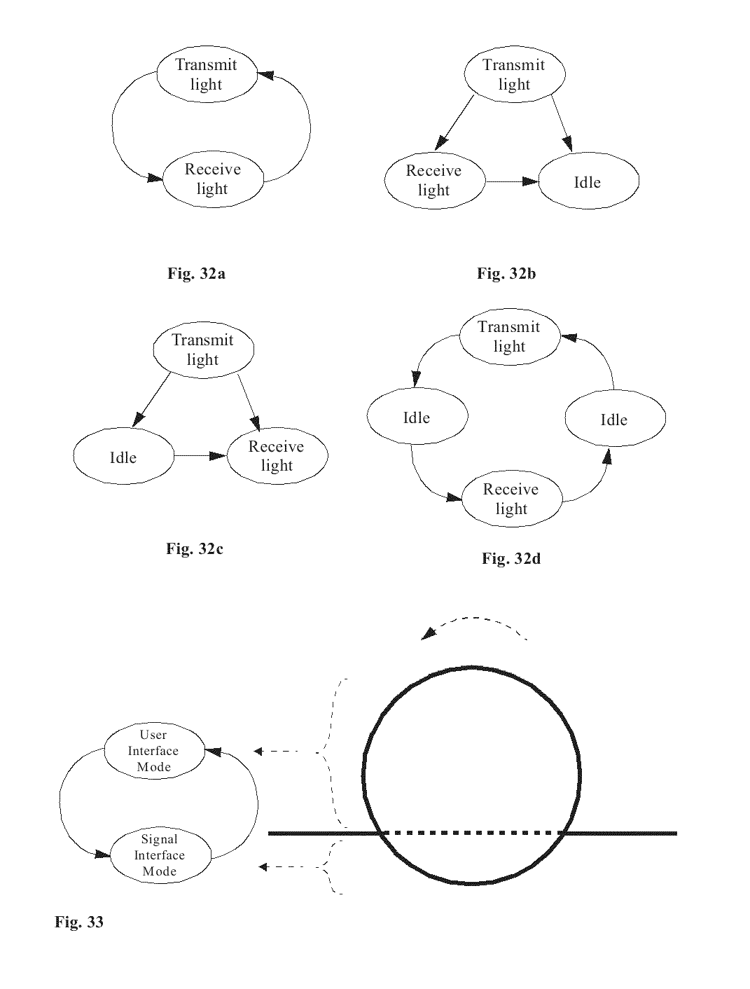

FIG. 32a illustrates an example two-state state transition diagram for the operating mode of a selected LED. FIG. 32b illustrates an example three-state state transition diagram for the operating mode of a selected LED. FIG. 32c illustrates another example three-state state transition diagram for the operating mode of a selected LED. FIG. 32d illustrates an example four-state state transition diagram for the operating mode of a selected LED. Other operating modes are also possible, for example those wherein LEDs have distinct modes called out for receiving of photovoltaically-obtained power. It is also possible to include the situation of receiving of photovoltaically-obtained power as a special case of received light in FIGS. 32a-32d.

An important special case of the use of LEDs in such manners is the use of OLED arrays such as those used in OLED displays increasingly deployed in cellphones, smartphones, and Personal Digital Assistants (“PDAs”) manufactured by Samsung, Nokia, LG, HTC, Phillips, Sony and others. As taught in pending U.S. Patent Application 61/506,634, such an arrangement can be implemented in a number of ways to provide a high-resolution optical tactile sensor for touch-based user interfaces. Color OLED array displays are of particular interest, in general and as pertaining to the present invention, because:
They can be fabricated (along with associated electrical wiring conductors) via printed electronics on a wide variety of surfaces such as glass, Mylar, plastics, paper, etc.;
Leveraging some such surface materials, they can be readily bent, printed on curved surfaces, etc.;
They can be transparent (and be interconnected with transparent conductors);
Leveraging such transparency, they can be:
   Stacked vertically,
   Used as an overlay element atop an LCD or other display,
   Used as an underlay element between an LCD and its associated backlight.

In an implementation, an OLED array employed by the invention is fabricated on the interior of a curved material. In an implementation, an OLED array employed by the invention is printed on the interior of a curved material.

In an embodiment, OLED devices that emit circularly polarized light in the visible light range can be used with circularly polarized glasses. For example, an OLED device that emits circularly polarized light in the visible light range has been developed by Eiji Shiko of the Japan Advanced Institute of Science and Technology (http;//www.oled-info.com/researchers-create-circularly-polarized-light-oleds-way-3d-displays, visited Dec. 11, 2011).

Additionally, it is noted that OLED displays can readily be fabricated by printing or other means to have resolutions of over 250-300 dots per inch, a resolution that, when used in image sensing mode, is sufficient to detect fingerprint minutia. Accordingly, in an embodiment the invention comprises a touch surface that can operate as a fingerprint sensor that can be used to provide authentication functions.

Further, it is noted that OLED displays can be configured to operate as a (lensless imaging) camera (as taught in U.S. Pat. Nos. 8,284,290 and 8,305,480. Accordingly, in an embodiment the invention comprises a touch surface that can operate as a lensless imaging camera. Such a camera can be configured to operate in still-image mode, configured to operate in real-time (video) mode, or configured to selectively operate in either of these modes. This real-time (video) mode capability can be used for video conferencing, and can also be used for non-touch 3-space hand-motion/body-motion gesture sensing as taught for example in section 2.1.7.2 of U.S. Pat. No. 6,570,078, pending U.S. patent application Ser. No. 10/683,915, U.S. patent application Ser. No. 13/706,214. Through proper imaging configuration, the real-time (video) mode capability can be used to implement eye-tracking user interfaces.

### Example Mechanical Support Arrangements

In some embodiments, the spherical touch and/or display surface device is configured as a mechanically free sphere or ball not employing any form of mechanical support. In other embodiments, a sphere can be mechanically supported in a wide variety of ways, for example by a saddle base, magnetic fields, rod, pins, pedestal, etc.

In various embodiments the mechanically supported sphere can be configured to freely rotate in space, configured to rotate over one or more directions of rotation with respect to a saddle base, or can be configured in a fixed position with respect to the support base so that it is unable to rotate.

When configured to rotate, the spherical touch and/or display surface can be configured to include sensing of at least its angular orientation in a variety of ways including magnetic, image, accelerometer, etc.

Earlier-presented FIG. 23c illustrates an example arrangement provided for by the invention wherein a spherical touch and/or display surface is employed as a larger-size sphere that is magnetically suspended wherein the sphere rotates around a vertically-aligned axis. Passive magnetic suspension is inherently unstable but can be stabilized by supplemental active electromagnetic servo arrangements and/or oscillating magnetic fields created by electromagnetic arrangements. Active magnetic suspension methods can be found, for example, in Magnetic and Electric Suspensions by Frazier, Gilinson, and Oberbeck, published by MIT Press, 1974 ISBN 0-262-06054-X and Electromagnetic Levitation and Suspension Techniques by Jayawant, published by Hodder Arnold, 1981 ISBN 0-713-13428-3. In an embodiment, the active electromagnetic servo arrangements and/or oscillating magnetic fields created by electromagnetic arrangements used in magnetic suspension of the spherical touch and/or display surface device can be used as a means to deliver power to the spherical touch and/or display surface device, employing transformer actions.

FIG. 23d illustrates an example arrangement provided for by the invention wherein a spherical touch and/or display surface is employed as a larger-size sphere that is connectively supported by an arc-and-pin mount in a manner wherein the sphere rotates around a horizontally-aligned axis.

### Internal Gyroscope

In an embodiment, the spherical touch and/or display surface device can comprise an internal gyroscope. In one example use, the internal gyroscope can be used to provide orientation information. The orientation information can be used in various ways, including the production of user interface signals.

In another example use, the internal gyroscope can be used to maintain the position of an internal surface within the spherical touch and/or display surface device.

In another example use, the internal gyroscope can be used to maintain the position of the entire spherical touch and/or display surface device.

### Internal Accelerometer

In an embodiment, the spherical touch and/or display surface device can comprise an internal accelerometer. In one example use, the internal accelerometer can be used to provide orientation accelerometer to produce user interface signals.

### Data Transmission Arrangements

In various embodiments, the spherical touch and/or display surface can transfer data in a variety of ways including one or more of magnetic, photoelectric, electrical circuit, radio link, etc.

In an embodiment, data signals can be encoded with Manchester or other zero-DC line code.

Electrical circuit data transfer can be used in approaches where support arrangements penetrate the spherical touch and/or display surface, such as in those depicted in FIGS. 23b, 23c, and 23d.

In an embodiment, Time-Division Multiplexing (TDM) or Wavelength-Division Multiplexing (WDM) can be used to separate data transmit and data receive channels.

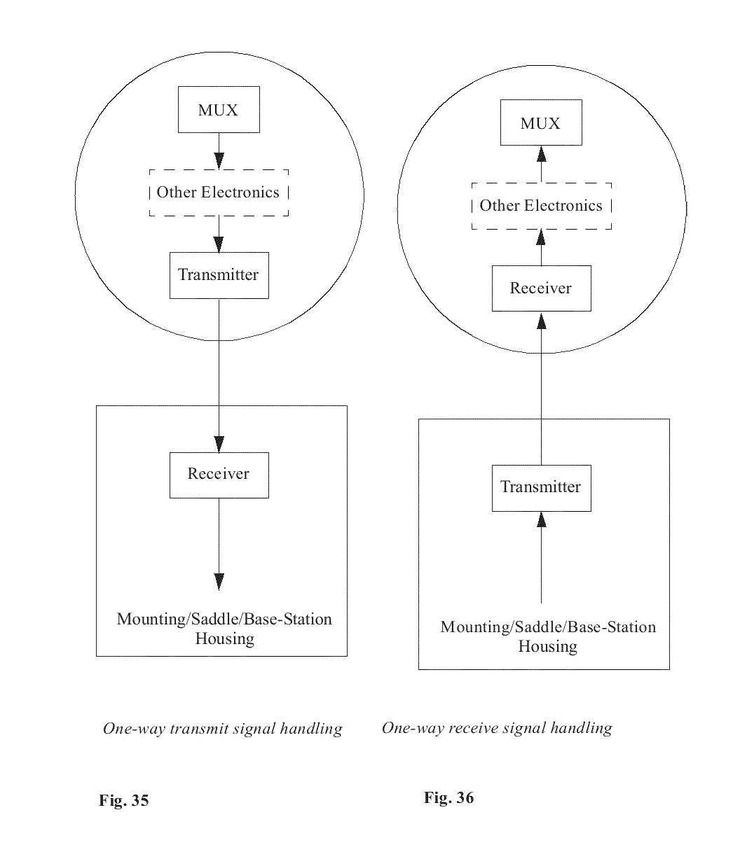

FIG. 35 illustrates an example one-way data transmission arrangement wherein data signals are transmitted from the spherical touch surface to an associated mounting, saddle, or base-station.

FIG. 36 illustrates an example one-way data reception arrangement wherein data signals are received by the spherical touch surface from an associated mounting, saddle, or base-station.

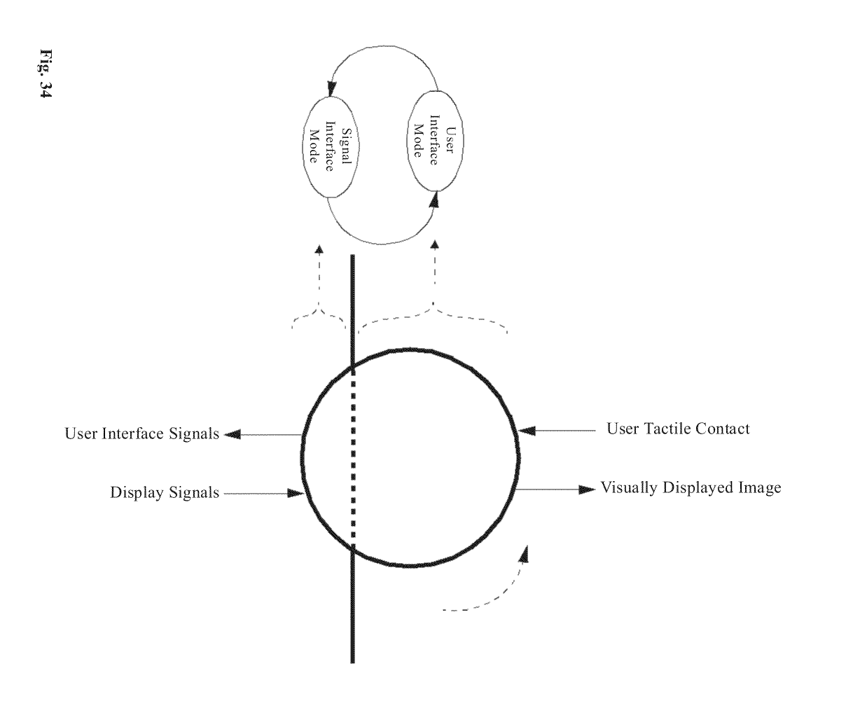

FIG. 33 illustrates an example two-mode mode transition diagram for the operating mode of selected elements of the spherical touch and/or display surface is determined by whether or not that element is in a region exposed to user finger touch or proximity.

FIG. 34 illustrates an example expansion of the arrangement of FIG. 33 wherein at least a region of the sphere that is not exposed to user finger touch or proximity is used for the transmission of user interface signals and/or the receiving of display signals.

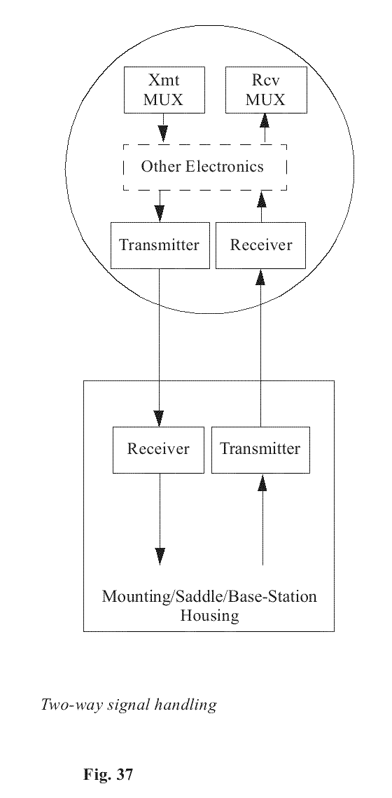

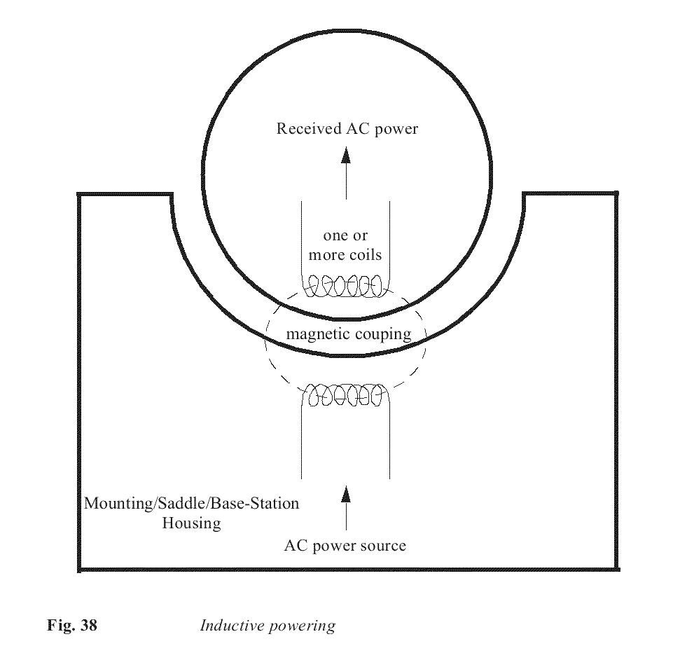

FIG. 37 illustrates an example two-way data transmission arrangement wherein data signals are transmitted from the spherical touch and/or display surface to an associated mounting, saddle, or base-station and data signals are received by the spherical touch and/or display surface from an associated mounting, saddle, or base-station.

### Powering Arrangements

In various embodiments, the spherical touch and/or display surface can be powered in ways including one or more of internal battery, internally generated or harvested power, and external power transferred by magnetic, photoelectric, electrical circuit, etc.

Electrical circuit powering can be used in approaches where support arrangements penetrate the spherical touch and/or display surface, such as in those depicted in FIGS. 23b, 23c, and 23d.

FIG. 38 illustrates an example inductive powering arrangement employing magnetically-coupled coils employing transformer actions.

In a particular case of inductive powering arrangement employing magnetically-coupled coils, active electromagnetic servo arrangements and/or oscillating magnetic fields created by electromagnetic arrangements used in a magnetic suspension arrangement of a spherical touch and/or display surface device can be used as a means to deliver power to the spherical touch and/or display surface device, employing transformer actions.

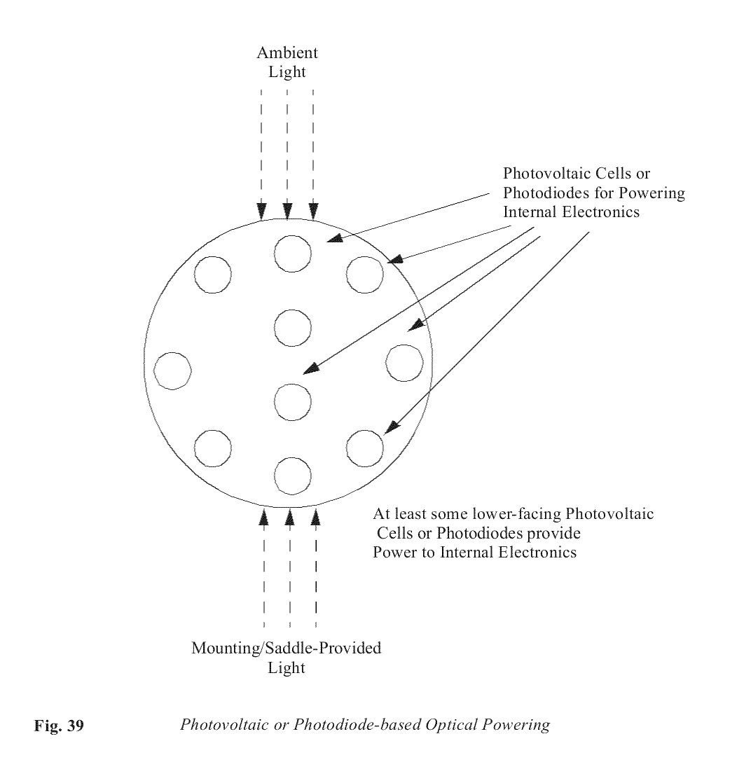

FIG. 39 illustrates an example optical powering arrangement employing photovoltaic cells or photodiodes. In one embodiment, photovoltaic cells or photodiodes are spatially distributed among LEDs beneath the touch surface. In another embodiment, photovoltaic cells or photodiodes are spatially distributed behind transparent LEDs or OLEDs beneath the touch surface.

In an embodiment, the wavelengths used to provide power via photovoltaic cells or photodiodes are non-visible wavelengths.

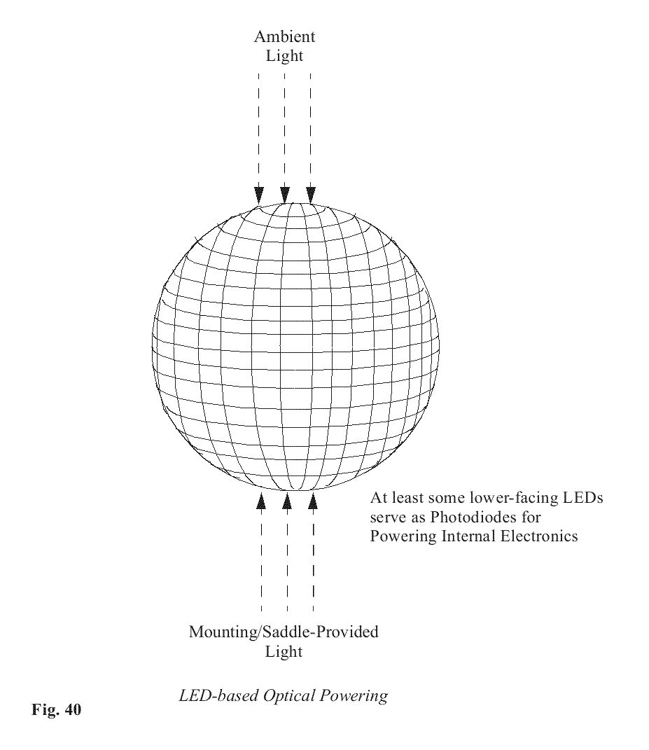

FIG. 40 illustrates another example optical powering arrangement wherein LEDs or OLEDs beneath the touch surface serve as energy-providing photodiodes for powering internal electronics via photovoltaic operation of the LEDs or OLEDs.

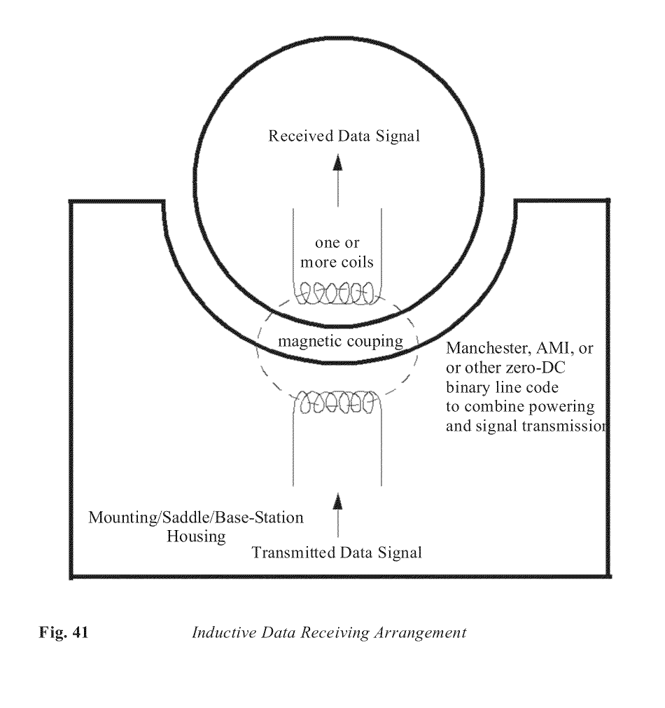

FIG. 41 illustrates an example one-way data reception arrangement wherein data signals are received by the spherical touch surface from an associated mounting, saddle, or base-station.

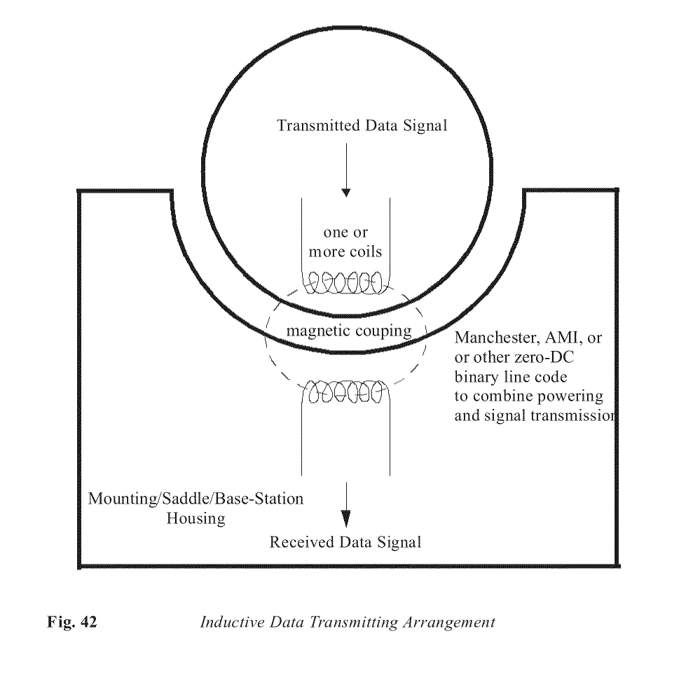

FIG. 42 illustrates an example one-way data transmission arrangement wherein data signals are transmitted from the spherical touch surface to an associated mounting, saddle, or base-station.

### Combining Optical Powering and Optical Data Transport

In various embodiments, the spherical touch and/or display surface can be powered by photoelectric arrangements and also transmit and/or receive data by optical data channels.

In an embodiment, data signals can be encoded with Manchester or other zero-DC line code.

In an embodiment, Time-Division Multiplexing (TDM) or Wavelength-Division Multiplexing (WDM) can be used to separate data transmit and data receive channels.

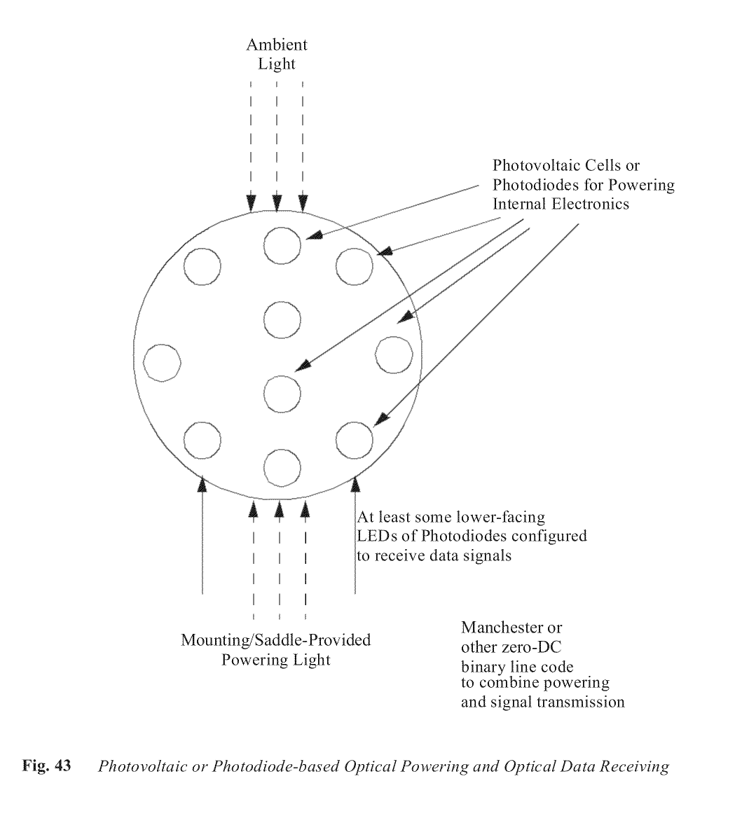

FIG. 43 illustrates an example arrangement wherein the arrangement of FIG. 39 is adapted so as to optical transfer data signals received by the spherical touch and/or display surface with optical powering. In an embodiment, light supplied for optical powering is applied to at least a first region of the spherical touch and/or display surface while data signals are transferred in at least a second region of the spherical touch and/or display surface.

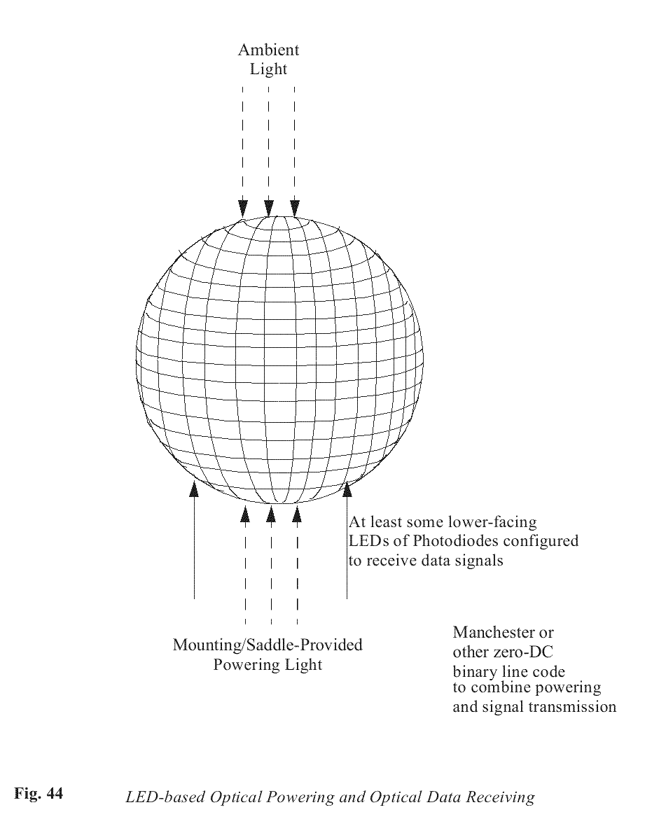

FIG. 44 illustrates an example arrangement wherein the arrangement of FIG. 40 is adapted so as to optical transfer data signals received by the spherical touch and/or display surface with optical powering wherein at least some lower-facing LEDs receive data signals. In an embodiment, light supplied for optical powering is applied to at least a first region of the spherical touch and/or display surface while data signals are transferred in at least a second region of the spherical touch and/or display surface. In an embodiment, the data signals can be encoded with Manchester or other zero-DC line code.

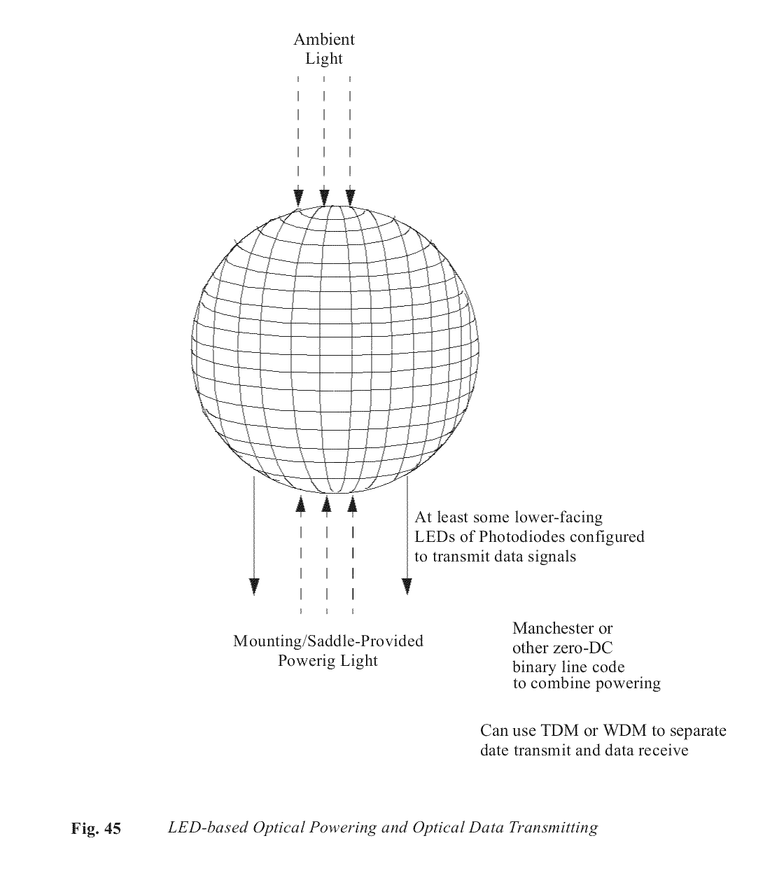

FIG. 45 illustrates an example arrangement wherein the arrangement of FIG. 40 is adapted so as to optical transfer data signals received by the spherical touch and/or display surface with optical powering wherein at least some lower-facing LEDs transmit data signals. In an embodiment, light supplied for optical powering is applied to at least a first region of the spherical touch and/or display surface while data signals are transferred in at least a second region of the spherical touch and/or display surface. In an embodiment, the data signals can be encoded with Manchester or other zero-DC line code. In an embodiment, Time-Division Multiplexing (TDM) or Wavelength-Division Multiplexing (WDM) can be used to separate data transmit and data receive channels.

### Rotation by User Fingers or Hand

In an embodiment, the spherical touch and/or display surface device can be rotated by the user fingers or hand, and one or more angles of this rotation can be used to create a user interface output signal responsive to angle of rotation. Rotational position and/or rotational angle sensing can be implemented in a variety of ways including sensing or counting of variations in optical signals or RF signals, mechanical rollers, magnetic, image, accelerometer, etc.

### Displayed Virtual Rotational

In an embodiment, the spherical touch and/or display surface device can be virtually rotated by controlled rotation of the displayed data and/or rotationally-transformed interpretation of touch/proximity locations.

### Motorized Positional and Rotational Transport

In an embodiment, the spherical touch and/or display surface device can be mechanically rotated by controlled motorized rotational transport.

In an embodiment, one or more spherical touch and/or display surface device(s) can be mechanically positioned by controlled motorized rotational transport. For example, models of a planetary system, moon system, star system, galactic system, atomic system, etc. can be built from a plurality of spherical touch and/or display surface devices that are mechanically positioned in controlled motion by controlled motorized rotational transport.

### Displacement by User Fingers or Hand

In an embodiment, the rest-position of the spherical touch and/or display surface device can be displaced by the user fingers or hand, and this can be used to create a user interface output signal. Displacement sensing can be implemented in a variety of ways including sensing or counting of variations in optical signals or RF signals, mechanical rollers, magnetic, image, accelerometer, etc.

### Example Applications

FIG. 46 depicts a system 4600 for providing multiple sensor configuration implementations of touch-based user interfaces, including those supporting gestures and HDTP (High-Dimensional Touch Pad) features according to an embodiment of the invention. System 4600 implements a user interface that receives a tactile input 4605, such as by touch contact by at least one finger of a human user. A tactile sensing arrangement 4610 generates tactile sensing measurements 4605 in response to the tactile input 4605 and provides tactile sensing measurements 4605 via interface electronics 4620 to a computational processor 4625. The processor 4625 stores instructions 4630 in memory, which upon execution, use the tactile sensing measurements 4605 to generate user interface output signals 4660.

As discussed earlier, FIG. 21 illustrates an example arrangement employing at least the general type of arrangement depicted in FIG. 46. provided for by the invention wherein a spherical touch and/or display surface is employed as a traditional rotating trackball. Track-ball rotational position, rotational angle, and displacement sensing can be implemented in a variety of ways including sensing or counting of variations in optical signals or RF signals, mechanical rollers, magnetic, image, accelerometer, etc.

Also as discussed earlier, FIG. 22 illustrates an example arrangement provided for by the invention wherein a spherical touch and/or display surface is employed as a moderate-size sphere supported by a saddle base. In various embodiments the sphere can be configured to rotate over one or more directions of rotation with respect to the saddle base or can be configured in a fixed position with respect to the saddle base so that it is unable to rotate. In arrangements where the sphere can rotate, position and displacement sensing can be implemented in a variety of ways including sensing or counting of variations in optical signals or RF signals, mechanical rollers, magnetic, image, accelerometer, etc.

Yet further, earlier-presented FIG. 23a illustrates an example arrangement provided for by the invention wherein a spherical touch and/or display surface is employed as a larger-size sphere supported by a saddle base. In various embodiments the sphere can be configured to rotate over one or more directions of rotation with respect to the saddle base or can be configured in a fixed position with respect to the saddle base so that it is unable to rotate. In arrangements where the sphere can rotate, position and displacement sensing can be implemented in a variety of ways including sensing or counting of variations in optical signals or RF signals, mechanical rollers, magnetic, image, accelerometer, etc. Earlier-presented FIG. 23b illustrates an example arrangement provided for by the invention wherein a spherical touch and/or display surface is employed as a larger-size sphere that is connectively supported by an arc-and-pin mount as used in geographic globes used to represent the Earth, Moon, planets, and planetary moons. Similarly, earlier-presented FIG. 23c depicts an example embodiment employing magnetic suspension.

As an example application, various types of topographical, environmental, meteorological, ecological, demographic, chemical composition, and other types of GIS visual data can be interactively displayed for one or more of the Earth, Moon, planets, and planetary moons. Additionally, various types of views of biological cells, physical devices, and abstract phenomena or data sets can be displayed in a manner that can be physically or virtually rotated and/or manipulated interactively by touch user interface operations.

In an embodiment, the spherical display can be operated in conjunction with various types of active or passive 3D glasses so as to produce 3D imaging on the surface of a spherical display. For example, an OLED device that emits circularly polarized light in the visible light range has been developed by Eiji Shiko of the Japan Advanced Institute of Science and Technology (http://www.oled-info.com/researchers-create-circularly-polarized-light-oleds-way-3d-displays, visited Dec. 11, 2011). A polarized light emission OLED array can be implemented beneath the spherical surface and used in conjunction with circularly polarized eye-glasses. As a second example, rapidly alternating display of left-eye and right-eye images can be synchronized with rapidly alternating display of left-eye and right-eye shuttering of LCD-shuttered eye-glasses.

As example applications for such an arrangement, various types of 3D views of biological cells, physical devices, and abstract phenomena or data sets can be displayed in a manner that can be physically or virtually rotated and/or manipulated interactively by touch user interface operations. Similarly, various types of 3D views of topographical, environmental, meteorological, ecological, demographic, chemical composition, and other types of GIS visual data can be interactively displayed for one or more of the Earth, Moon, planets, and planetary moons.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Although exemplary embodiments have been provided in detail, various changes, substitutions and alternations could be made thereto without departing from spirit and scope of the disclosed subject matter as defined by the appended claims. Variations described for the embodiments may be realized in any combination desirable for each particular application. Thus particular limitations and embodiment enhancements described herein, which may have particular advantages to a particular application, need not be used for all applications. Also, not all limitations need be implemented in methods, systems, and apparatuses including one or more concepts described with relation to the provided embodiments. Therefore, the invention properly is to be construed with reference to the claims.

We claim:

1. A system for implementing a user interface comprising a spherically-shaped touch surface, the system comprising:
a spherically-shaped tactile sensing arrangement for generating tactile sensing measurements in response to tactile input on a spherically-shaped surface; and
a processor for receiving the tactile sensing measurements and executing instructions to:
process the tactile sensing measurements,
recognize at least one user interface event responsive to the tactile sensing measurements,
generate user interface output signals responsive to the recognition event,
wherein the system produces user interface output signals responsive to user touch.

2. The system of claim 1, further comprising a measurement signal transmission arrangement for transmitting the tactile sensing measurements to the processor.

3. The system of claim 2 wherein the signal transmission arrangement comprises an optical transmitter arrangement and an optical receiver arrangement.

4. The system of claim 2 wherein the signal transmission arrangement comprises an inductive transmitter arrangement and an inductive receiver arrangement.

5. The system of claim 2 wherein the signal transmission arrangement comprises an electric circuit.

6. The system of claim 2 wherein the signal transmission arrangement comprises a radio link.

7. The system of claim 1, further comprising a user interface signal transmission arrangement for transmitting the user interface output signals from the processor.

8. The system of claim 7 wherein the signal transmission arrangement comprises an optical transmitter arrangement and an optical receiver arrangement.

9. The system of claim 7 wherein the signal transmission arrangement comprises an inductive transmitter arrangement and an inductive receiver arrangement.

10. The system of claim 7 wherein the signal transmission arrangement comprises an electric circuit.

11. The system of claim 7 wherein the signal transmission arrangement comprises a radio link.

12. The system of claim 1 wherein the tactile sensing arrangement comprises a capacitive matrix.

13. The system of claim 1 wherein the tactile sensing arrangement comprises an array of light emitting diodes (LEDs).

14. The system of claim 13 wherein the light emitting diodes (LEDs) are organic light emitting diodes (OLEDs).

15. The system of claim 13 wherein the tactile sensing arrangement is further configured to operate as a lensless camera.

16. The system of claim 13 wherein the tactile sensing arrangement is further configured to operate as a fingerprint sensor.

17. The system of claim 13 wherein the tactile sensing arrangement is further configured to operate as a 3-space hand gesture user interface.

18. The system of claim 1 wherein the system is configured to recognize at least one touch gesture.

19. The system of claim 1 wherein the system is configured to recognize at least one touch location.

20. The system of claim 1 wherein the system is configured to recognize multi-touch.
